(19) United States
(12) Patent Application Publication
(10) Pub. No.: US 2020/0169725 A1
(43) Pub. Date: May 28, 2020

(54) MULTILAYER HIGH-DYNAMIC-RANGE HEAD-MOUNTED DISPLAY

(71) Applicant: Arizona Board Regents on Behalf of the University of Arizona, Tucson, AZ (US)

(72) Inventors: Hong Hua, Tucson, AZ (US); Miaomiao Xu, Tucson, AZ (US)

(21) Appl. No.: 16/613,833

(22) PCT Filed: May 18, 2018
(86) PCT No.: PCT/US18/33430

§ 371 Date: Nov. 15, 2019

Related U.S. Application Data
(60) Provisional application No. 62/508,202, filed on May 18, 2017.

(51) Int. Cl. H04N 13/339; G02B 27/01; G02B 30/52

(52) U.S. Cl. CPC H04N 13/339; H04N 13/327; G02B 30/52; G02B 27/0172

(57) ABSTRACT

Multilayer high-dynamic-range head-mounted display.

### RELATED APPLICATIONS

This application claims the benefit of priority of U.S. Provisional Application No. 62/508,202, filed on May 18, 2017, the entire contents of which application(s) are incorporated herein by reference.

### TECHNICAL FIELD

The present invention relates generally to optical systems and, in particular but not exclusively, to head-mounted displays.

### BACKGROUND

A head mounted display (“HMD”) is a display device worn on or about the head. HMDs usually incorporate some sort of near-to-eye optical system configured to form a virtual image located in front of the viewer. Displays configured for use with a single eye are referred to as monocular HMDs, while displays configured for use with both eyes are referred to as binocular HMDs.

A HMD is one of the key enabling technologies for virtual reality (VR) and augmented reality (AR) systems. HMDs have been developed for a wide range of applications. For instance, a lightweight “optical see-through” HMD (OST-HMD) enables optical superposition of two-dimensional (2D) or three-dimensional (3D) digital information onto a user's direct view of the physical world, and maintains see-through vision to the real world. OST-HMD is viewed as a transformative technology in the digital age, enabling new ways of accessing digital information essential to our daily life. In recent years significant advancements have been made toward the development of high-performance HMD products and several HMD products are commercially deployed.

Despite the progress with HMD technologies, one of the key limitations of the state-of-the-art is the low dynamic range (LDR) of a HMD. The dynamic range of a display or a display unit is commonly defined as the ratio between the brightest and the darkest luminance that the display can produce, or a range of luminance that a display unit can generate.

Most of the state-of-the-art color displays (including HMDs) are only capable of rendering images with 8-bit depth per color channel, or a maximum of 256 discrete intensity levels. Such low dynamic range is far below the broad dynamic range of real-world scenes, which can reach up to 14 orders of magnitude. Meanwhile, the perceivable luminance variation range of the human visual system is known to be above 5 orders of magnitude without adaptation. For immersive VR applications, images produced by, or associated with, LDR HMDs fall short of rendering scenes with large contrast variations. This, of course, may result in loss of fine structural details, and/or loss of high image fidelity, and/or loss of sense of immersion as far as the user/viewer is concerned. For the “optical see-through” AR applications, virtual images displayed by LDR HMDs may appear to be washed out with highly compromised spatial details when merged with a real-world scene, which likely contains a much wider dynamic range, possibly exceeding that of the LDR HMD's by several orders of magnitude.

The most common method of displaying a high dynamic range (HDR) image on a conventional LDR display is to adopt a tone-mapping technique, which compresses the HDR image to fit the dynamic range of the LDR device while maintaining the image integrity. Although a tone-mapping technique can make HDR images accessible through conventional displays of nominal dynamic range, such accessibility comes at the cost of reduced image contrast (which is subject to the limit of the device's dynamic range), and it does not prevent the displayed images being washed out in an AR display.

Therefore, developing hardware solutions for HDR-HMD technologies becomes very important, especially for AR applications.

### SUMMARY

Accordingly, in one of its aspects the present invention may provide a display system having an axis and comprising first and second display layers, and an optical system disposed between said first and second display layers, the optical system configured to form an optical image of a first predefined area of the first display layer on a second predefined area of the second layer. As used in this context “on a second predefined area of the second layer”, may include that the optical system is configured to form an optical image of said second area on said first area, or that the second display layer is spatially separated from a plane that is optically-conjugate to a plane of the first display layer. The optical system may be configured to establish a unique one-to-one imaging correspondence between the first and second areas.

At least one of the first and second display layers may be a pixelated display layer, and the first area may include a first group of pixels of the first display layer, the second area may include a second group of pixels of the second display layer, where the first and second areas may be optical conjugates of one another. The first display layer may have a first dynamic range, and the second display layer may have a second dynamic range. The display system may have a system dynamic range with a value of which is a product of values of the first and second dynamic ranges. Further, the optical system may be configured to image said first area onto said second area with a unit lateral magnification.

The display system may be a head mounted display and may include a light source disposed in optical communication with the first display layer. The first display layer may be configured to modulate the light received from the source, and the second display layer may be configured to receive the modulated light from the first display layer, with the second display layer configured to further modulate the received light. The display system may also include an eyepiece for receiving the modulated light from the second display layer. One or both of the first and second display layers may include a reflective spatial light modulator, such as a LCoS. Alternatively, or additionally, one or both of the first and second display layers may include a transmissive spatial light modulator, such as a LCD. Further, the optical system may be telecentric at one or both of the first display layer and the second display layer. Typically, the optical system between the first and second display layers may be an optical relay system.

### BRIEF DESCRIPTION OF THE DRAWINGS

The foregoing summary and the following detailed description of exemplary embodiments of the present invention may be further understood when read in conjunction with the appended drawings, in which like elements are numbered alike throughout:

FIGS. 1A, 1B schematically illustrate a direct-view type desktop display with differing gap distance between layers of spatial light modulators (SLMs);

FIGS. 2A, 2B schematically illustrate exemplary configurations of HDR-HMD (high dynamic range, head mounted display) systems in accordance with the present invention;

FIG. 3 schematically illustrates exemplary configurations of a HDR display engine with two or more SLM layers in accordance with the present invention;

FIGS. 4A-4C schematically illustrate exemplary layouts of LCoS-LCD HDR-HMD embodiments in accordance with the present invention, with FIG. 4C showing the unfolded light path of FIGS. 4A, 4B;

FIGS. 5A-5C schematically illustrate exemplary layouts of two-LCoS layer based HDR-HMD embodiments in accordance with the present invention, with FIG. 5C showing the unfolded light path of FIGS. 5A, 5B;

FIGS. 6A-6C schematically illustrate exemplary configurations of a light path before (FIG. 6A) and after (FIGS. 6B, 6C) introducing a relay system in accordance with the present invention;

FIGS. 7A, 7B schematically illustrate exemplary configurations of LCoS-LCD HDR HMD with an optical relay in accordance with the present invention;

FIGS. 8, 9 schematically illustrate exemplary configurations of two-LCoS modulation with image relay in accordance with the present invention, in which FIG. 8 shows a configuration in which the light passes through relay system twice, FIG. 9 shows a configuration with single-pass relay;

FIG. 10 schematically illustrates another compact HDR display engine in accordance with the present invention, in which a mirror and an objective are used between two micro-displays;

FIG. 11 schematically illustrates one exemplary proposed HDR HMD system in accordance with the present invention;

FIG. 12 schematically illustrates a top view of a WGF (wire grid film) cover of a LCoS;

FIG. 13 schematically illustrates a cubic PBS;

FIGS. 14A-14E schematically illustrate optimized results for the proposed layout of FIG. 11, with FIG. 14A showing the optical layout and FIGS. 14B-14E showing the optical system performance after global optimization;

FIGS. 15A-15G schematically illustrates optimized results of the system of FIG. 14A in which all lenses are matched with off-the-shelf components, with FIG. 15A showing the optical layout and FIGS. 15B-15G showing the optical system performance;

FIG. 16 illustrates a prototype that was built for the HDR display engine of FIG. 15A;

FIG. 17 schematically illustrates an HDR-HMD calibration and rendering algorithm in accordance with the present invention;

FIG. 18 schematically illustrates the light path for each LCoS image formed;

FIG. 19 schematically illustrates a procedure of HMD geometric calibration in accordance with the present invention;

FIG. 20 schematically illustrates a flow chart for an image alignment algorithm in accordance with the present invention;

FIG. 21 schematically illustrates the projections of LCoS1 image L1 and LCoS2 image L2 according the algorithm of FIG. 20;

FIG. 22 schematically illustrates an example of how the algorithm of FIG. 20 works for each LCoS image;

FIG. 23 schematically illustrates grid image aligning results when displaying the post-process LCoS images onto two displays simultaneously;

FIGS. 24A-24C schematically illustrate residual alignment error, with FIGS. 24A, 24B showing exemplary test pattern, and FIG. 24C showing the plot of residual error for the circular sampling position shown in FIG. 24B;

FIG. 25 shows a tone response curve interpolated using a piecewise cubic polynomial;

FIG. 26 shows a procedure for HDR HMD radiance calibration in accordance with the present invention;

FIGS. 27A-27D show further aspects of the procedure of FIG. 26, in which FIG. 27A shows the absolute luminance value for a captured HMD image, FIG. 27B shows the camera intrinsic radiance, FIG. 27C shows the HMD intrinsic radiance, FIG. 27D shows the corrected uniformity;

FIGS. 28A, 28B show a pair of rendered image displayed on LCoS1 and LCoS2 after processing both alignment and radiance rendering algorithm;

FIG. 28C shows a result for the background uniformity correction;

FIG. 29 shows a HDR image radiance rendering algorithm in accordance with the present invention;

FIG. 30 shows tone response curves calculated using the HDR image radiance rendering algorithm in accordance with the present invention;

FIG. 31 shows a target image and its frequency domain after downsampling by different low pass filters; and

FIG. 32A-32D show an original target HDR image after tone-mapping (FIG. 32A) and display of HDR and LDR images.

### DETAILED DESCRIPTION

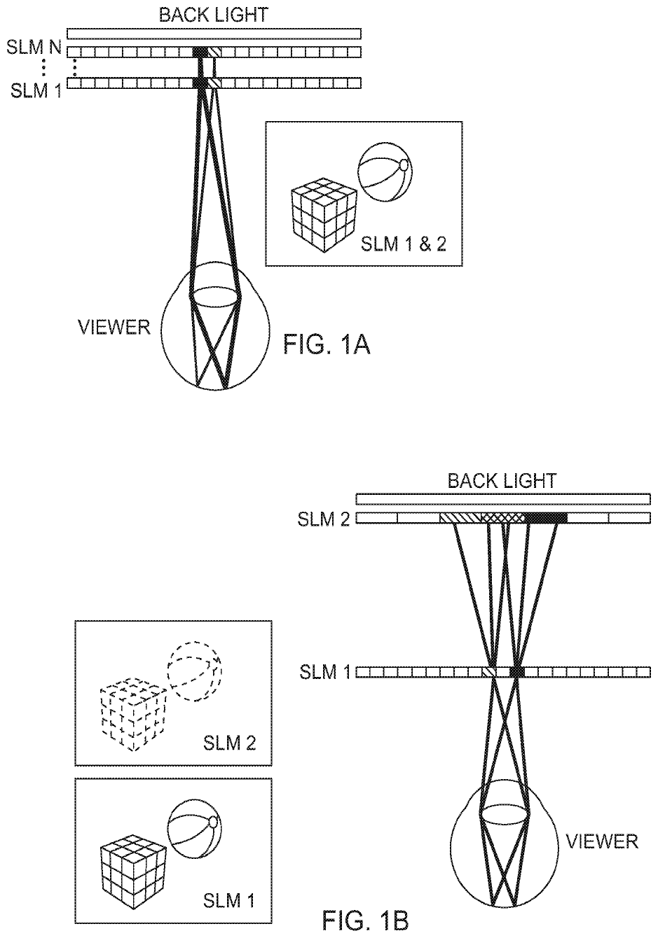

The present inventors recognize that art in the field of high dynamic range (HDR) displays for direct-view type desktop applications has been discussing some hardware solutions, and perhaps the most straightforward method towards achieving a HDR display is to attempt to increase the maximum of the practically-displayable luminance level and to increase the addressable bit-depth for each of the color channels of the display pixels. The present inventors recognize that this approach, however, requires high-amplitude, high-resolution drive electronic circuits as well as light sources possessing high luminance, both of which are not easy to implement at practically-reasonable cost. In accordance with the present invention, another method may be employed—to combine two or more device layers—for example, layers of spatial light modulators (SLMs)—to be able to simultaneously control the light output produced by pixels. In the spirit of this approach, the present inventors have conceived of use of art relating to an HDR display schematic for direct-view desktop displays, which was based on a dual-layer spatial light-modulating scheme. Being different from conventional liquid-crystal displays (LCDs) that utilize uniform backlighting, this solution employed a projector to provide spatially-modulated light source for a transmissive LCD in order to achieve a dual-layer modulation and a 16-bit dynamic range with two 8-bit SLMs. This solution also demonstrated an alternative implementation of the dual-layer modulation scheme, in which an LED array, driven by spatially-varying electrical signals, was used to replace the projector unit and provided a spatially-varying light source to an LCD. FIGS. 1A and 1B provide schematic illustrations of the demonstrated configurations. More recently, the use of multi-layer multiplicative modulation and compressive light field factorization method for HDR displays was attempted.

While one could think that the aforementioned multi-layer modulation scheme developed specifically for direct-view desktop displays can be adopted to the design of an HDR-HMD system—for example, by directly stacking two or more miniature SLM layers (along with a backlight source and an eyepiece), the present inventors have discovered that practical attempts to do so convincingly prove that such “direct stacking of multiple layers of SLMs” exhibits several critical structural and operational shortcomings, which severely limit an HDR-HMD system, making the so-structured HDR-HMD system practically meaningless.

To illustrate the practical problem(s) that persist in related art, upon reviewing the teachings of the present patent application, a person of skill would appreciate that (in reference to FIGS. 1A, 1B) the individual SLM layers for HDR rendering need to be placed close to each other, and the light source BACKLIGHT is successively modulated by the two SLMs in sequence. First of all, due to the physical construction of a typical overall SLM panel or unit (that includes multiple layers such as LCDs, for example), the modulation layers of the SLM panels are inevitably separated by a gap as large as a few millimeters, depending on the physical thickness of the panel. For a direct-view type desktop display as shown in FIG. 1A, a few millimeter-gap between two SLM layers does not necessarily have much influence on the modulation of a dynamic range. In an HMD system, on the other hand, where each of the SLM layers is optically magnified with a large magnification coefficient (of the HMD eyepiece component), even a gap as small as 1 millimeter in the SLM stack leads to a large separation in the viewing space, which makes accurate dynamic range modulation extremely complicated if possible at all. For instance, a 1-mm gap in the SLM stack leads to an axial separation of approximately 2.5 meters when an eyepiece with a 50× lateral magnification is used. Secondly, transmissive SLMs tend to have low dynamic range and low transmittance. Stacked dual-layer modulation, therefore, leads to very low light efficiency and limited dynamic range enhancement. Thirdly, transmissive SLMs tend to have a relatively low fill factor, and the microdisplays utilized in HMDs typically have pixels as small as a few microns (which is much smaller than the pixel size of about 200˜500 microns of direct-view displays). As a result, the light transmission through a two-layer SLM stack inevitably suffers from severe diffraction effects and yields poor image resolution, following a magnification upon the transmission through an eyepiece.

An LED array approach would be also readily understood as substantially impractical, not only because of the spatial separation between the layers, but also due to the limited resolution of an LED array. The common microdisplays used for HMDs are less than an inch diagonally (sometimes only a few millimeters) with very high pixel density, and thus only a few LEDs can fit within this size, which makes spatially-varying light source modulation impractical.

Implementations of the idea of the present invention address these shortcomings, and, in contradistinction with related art, make the multi-layer configuration of the HDR-HMD system not only possible but functionally advantageous. Specifically, for example, in various of its aspects the present invention may address the following:
The problem of the inability of existing multilayer HMDs to achieve dynamic ranges of irradiance or luminance that are defined by, and equal to, a product of dynamic ranges of the constituent display layers is solved by including, in a multilayer display, an optical imaging system configured such that display layers (between which, such optical imaging system is installed) are separated from one another by a substantially zero optical distance in that light emanating from a given point of one of these layers is perceived by the viewer as emanating from a uniquely-corresponding point of another layer.
The problem of inability to set, choose, and/or control a value of the dynamic range of existing multilayer HMDs is solved by using an optical imaging system, disposed between the layers of the multilayer HMD, to form an image of one of such layers in an image plane and disposing another of such layers either at the image plane itself or away from it at a separation distance judiciously determined to reduce the dynamic range of the multilayer HMD by a chosen amount with respect to the theoretical maximum value of the dynamic range. As a result, embodiments of the invention are configured to exhibit a dynamic range value that is chosen equal to either a theoretical maximum of the dynamic range (available for a given multilayer HMD system) or a pre-determined value that is smaller than such theoretical maximum.
The problems of low transmissivity and the presence of high diffraction artifacts, typical of multilayer HMDs of related art, are solved by utilizing, in a multilayer display of the invention, reflective SLMs with high pixel fill factors and high reflectivity. The neighboring SLM layers of an embodiment of the invention are reflective, and configured to spatially-consecutively modulate light from a light source in a substantially optically-conjugate geometry, when one of these layers is substantially optically-conjugate to another (through an optical system placed in between the neighboring SLM layers). As a result, the neighboring SLM layers operate as if they were separated from one another by a substantially zero optical distance. The so-configured consecutive modulation of light from a light source creates high dynamic range modulation while, at the same time, maintaining high light efficiency and low level of diffraction artifacts.

For the purposes of the following disclosure and unless expressly specified otherwise:
In a case when a display device or system includes multiple display units in optical sequence with one another and is configured such that light emitted from or generated by one of these display units is transferred or relayed to another of the display units (so that said other display unit defines the plane of observation for a user), the functional display unit that forms the plane of observation is referred to herein as the “display layer.” The remaining constituent functional display units of the display device (which may precede the display layer in the sequence of units) are referred to as modulation layers, and the overall display system is understood to be a multilayer display system.
First and second planes are understood to be, and referred to as, optically-conjugate planes when the second plane is such that first points on the first plane are imaged (with the use of a chosen optical system) onto the second points in the second plane and vice versa—in other words, if the points of the object and points of the image of such object are optically interchangeable. Accordingly, points that span areas of the object and the image in optically-conjugate planes are referred to as optically-conjugate points. In one example, first and second 2D arrays of pixels separated by an optical imaging system (such as a lens, for example) are considered to be optically-conjugate to one another if a given pixel of the first array is imaged precisely and only onto a given pixel of the second array through the optical system and vice versa, such as to establish a unique optical correspondence between each two “object” and “image” pixels of these arrays. In a related example, the optically-conjugate to one another first and second 2D arrays of pixels that are separated by an optical imaging system that is configured to image a given pixel of the first array onto an identified group of pixels of the second array such as to establish a unique optical correspondence between these two “object” and “image” groups of pixels of these two arrays.

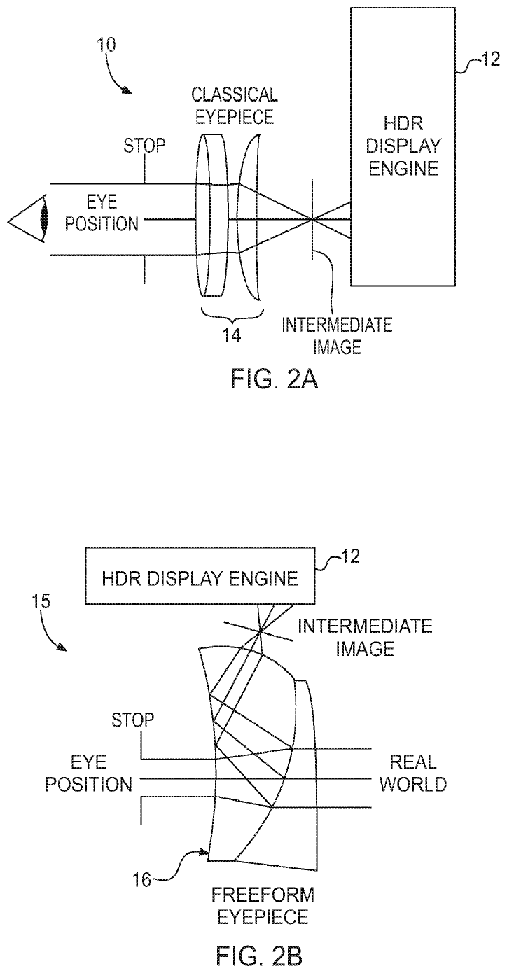

Generally, implementations of HMD optical systems 10, 15 according to the idea of the invention includes two sub-systems or parts—an HDR display engine 12 and an (optional) HMD viewing optics 14, 16 (such as an eyepiece or optical combiner), FIGS. 2A, 2B. The HDR display engine 12 is a sub-system configured to generate and provide the scene or image with an extended contrast ratio. In practice, the HDR display engine 12 would finally produce the HDR image at a nominal image plane inside or outside the HDR display system 10, 15. The nominal image location is denoted as the “intermediate image” when the system 10, 15 is coupled with other optics, such as the eyepiece 14, 16 in FIGS. 2A, 2B, as this image would then be magnified and shown at the front of the viewers by the eyepiece 14, 16.

The HDR display engine 12 can be optically coupled with different types and configurations of the viewing optics 14, 16. Following with the classification of normal head mounted display, the HDR-HMD system 10, 15 can be generally classified under two types, the immersive (FIG. 2A) and see-through (FIG. 2B). The immersive type blocks the optical path of light arriving from the real-world scene, whereas see-through optics combines the synthetic images with scenery of the real world. FIGS. 2A, 2B show two schematic examples of general layouts of the system. FIG. 2A is an immersive type HDR-HMD with a classical eyepiece 14 as viewing optics, whereas FIG. 2B illustrates a see-through HDR-HMD (with a specific freeform eyepiece prism 16). It should be understood that the HDR-HMD 10, 15 is not limited, of course, to these particular arrangements.

Throughout this disclosure, for convenience and simplicity of illustration and discussion, the (optional) viewing optics sub-system of an HDR-HMD is shown in the following as a single lens element, while it is of course intended and appreciated that various complex configuration of the viewing optics can be employed. The basic principle implemented in the construction of an HDR display engine is to use one spatial light modulator (SLM) or layer modulating another SLM or layer.

### Example 1: HDR Display Engine: Stacking Transmissive SLMs

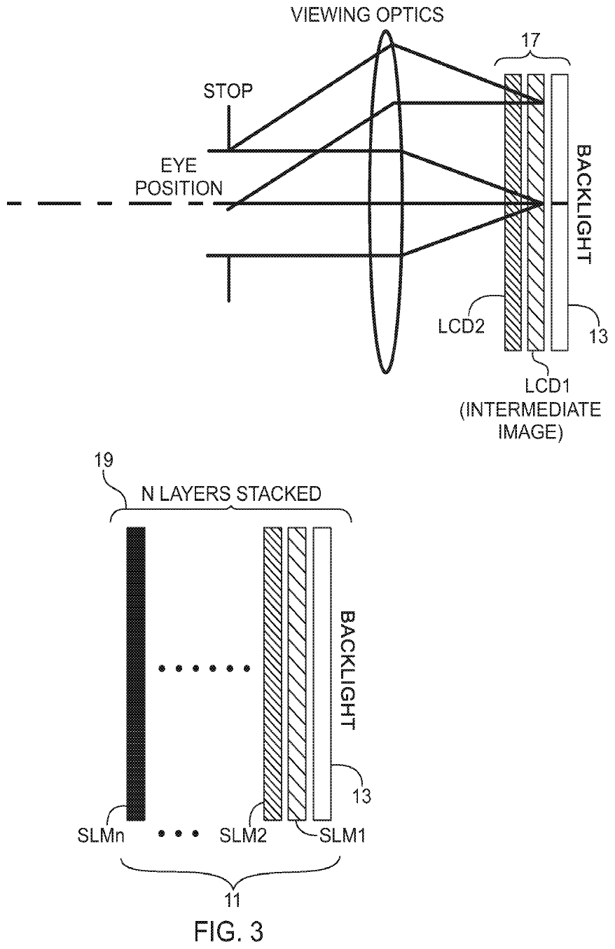

A most straightforward thinking for achieving multiple layer modulation simultaneously is to stack multiple transmissive SLMs 11 (or LCD1/LCD2) at the front of an illumination light, such as backlight 13, as shown in FIG. 3. The backlighting of the stacked SLMs HDR engine 17, 19 should offer illumination with high luminance. It could be monochromatic or polychromatic, either with an array at the back of a transmissive display (for SLM1) or a one-piece illumination source (LED, bulb, etc.) located at the display edge. A first SLM panel LCD1 may be located in front (i.e., closer to the backlight 13) of a second SLM panel LCD2, and may be used to modulate light from the backlight 13 before the light arrives at the second SLM panel LCD2. The intermediate image plane would be located at the position of LCD1, where the image was first modulated.

An advantage of the configuration of FIG. 3 is its compactness. A liquid crystal layer of a typical TFT LCD panel is about 1 to about 7 microns thick. Even considering the thickness of electrode(s) and cover glasses, the total thickness of an LCD is only several millimeters. Because the exemplary HDR display engine 17, 19 of FIG. 3 employs simply-stacked multiple (at a minimum—two) LCDs, the total track length of the HDR engine wound very compact. Furthermore, the use of an LCD has advantages in terms of power conservation as well as heat production.

However, the HDR display engine 17, 19 employing the simply-stacked LCDs possesses clear limitations. The basic structure of an LCD is known to include a liquid crystal layer between two glass plates with polarizing filters. The light-modulating mechanism of an LCD is to induce the rotation of the polarization vector of the incident light by electrically driving the orientation of liquid crystal molecules, and then to filter light with a certain state of polarization with the use of linear and/or circular polarizer. The incident light would inevitably be filtered and absorbed when transmitting through an LCD. The polarizing filters absorb at least a half of the incident light during the transmission, even in the “on” state of the device (characterized by maximum light transmittance), causing significant reduction of light throughput. Typical optical efficiency of an active matrix LCD is even smaller, less than 15%. In addition, the transmissive LCD has difficulties with producing dark and very dark “gray levels”, which leads to a relatively narrow range of contrast that the transmissive LCD can demonstrate. Although the setup of FIG. 3 can achieve a higher dynamic range than that of a single layer LCD alone, the attempts of extending contrast ratio and the illuminance of the overall display engine is limited by the transmission characteristics of the LC panel.

### Example 2: HDR Display Engine: Reflective SLM-Transmissive SLM

In order to increase light efficiency and contrast ratio of a multilayer HDR display engine in accordance with the present invention, a reflective SLM, such as liquid crystal on Silicon (LCoS) panel or digital mirror array (DMP) panel, can be used in combination with a transmissive SLM, such as an LCD. LCoS is a reflective type LC display, which uses a silicon wafer as a driving backplane and modulates light intensity in reflection. Specifically, a liquid crystal material can be used to form a coating over a silicon CMOS chip, in which case the CMOS chip acts as the reflective surface with a polarizer and liquid crystal on its top cover. The LCoS-based display has several advantages over the transmissive LCD-based one. First, a reflective type microdisplay has higher modulation efficiency and higher contrast ratio as compared with the transmissive type (LCD-based) that loses a large portion of efficiency during the transmission of light. Second, due to higher density of electronic circuitry in the back of the substrate, LCoS tends to have relatively high fill factor, and typically has smaller pixel size (that can be as small as a few microns). Besides, LCoS is easier and less expensive to manufacture than an LCD.

Due to the reflective nature of LCoS, the structure of stacked-together LCoS-based SLMs is no longer feasible. Indeed, LCoS is not a self-emissive microdisplay element and, therefore, high efficiency and illumination of this element is required for operation. Furthermore, light modulation with the use of LCoS is achieved by manipulating the light retardance with switching the direction of orientation of liquid crystal and then filtering light with a polarizer. In order to obtain higher light efficiency and contrast ratio, a polarizer should be employed right after the light source, to obtain a polarized illumination. Separating the incident and reflected light presents another practical issue. A polarized beam splitter (PBS) can be used in this embodiment to split the input light and the modulated light and redirect them along different paths.

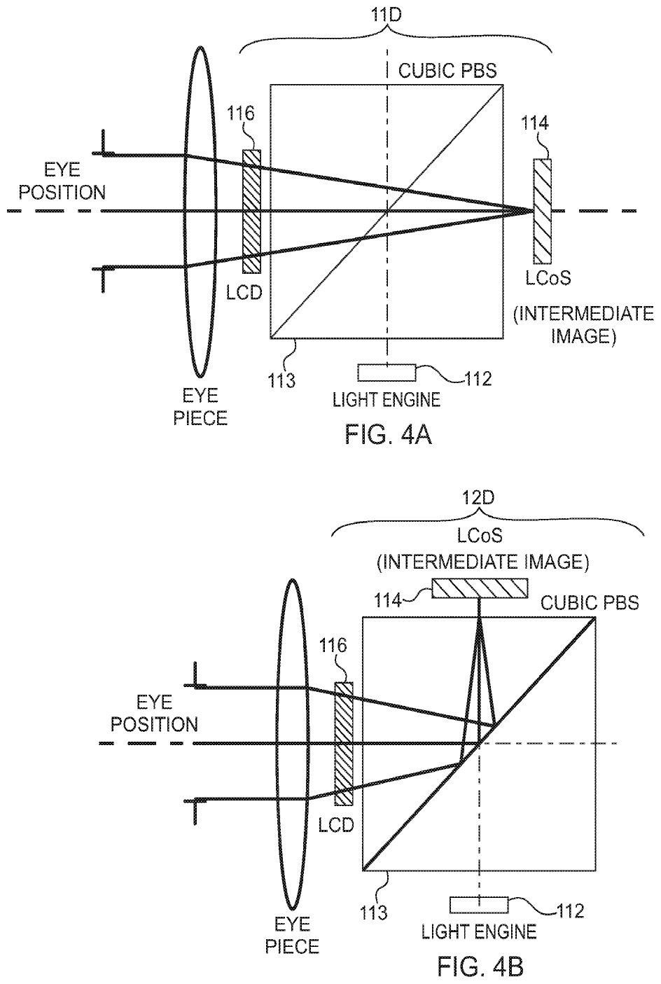

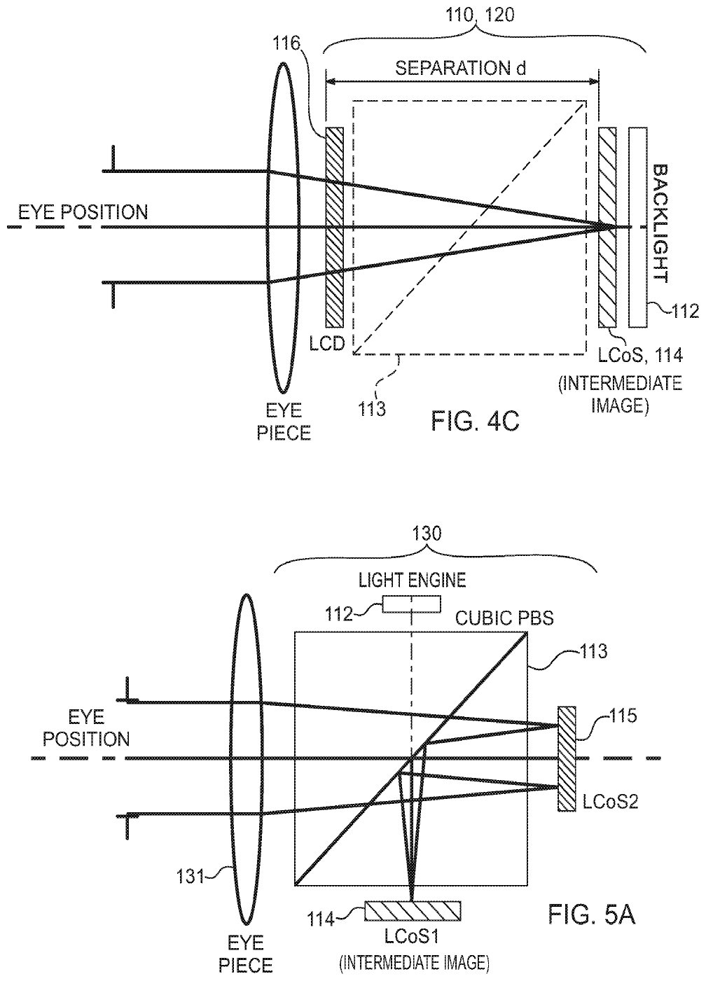

FIGS. 4A, 4B show the layout of an LCoS-LCD HDR-HMD embodiment in accordance with the present invention. Depending on the direction of a vector of the light source polarization, two different configurations of the display engine 110, 120 are possible (that of FIG. 4A, and that of FIG. 4B). The light engine 112 provides uniform polarized illumination to the LCoS 114 through a polarized beam splitter (PBS) which may be a cubic PBS 113. The light from the light source 112 may be modulated and reflected back by the LCoS 114, then transmitted through a LCD 116.

Although implementations of FIGS. 4A, 4B have subtle difference due to light source polarization direction, the unfolded light path is substantially the same, as shown in FIG. 4C. Assuming that the light engine 110, 120 offers uniform illumination at the position of the LCoS 114 (just as uniform as the backlight 13 of FIG. 3), the unfolded light path would be quite similar to that of FIG. 3, but the engines 110, 120 are characterized by a much larger separation d between the two SLM layers 114, 116, FIG. 4C. This distance d depends on the size of the PBS 113, as well as the dimension(s) of the ray bundle. Due to the large separation, the ray bundle that exits from LCoS 114 would project onto the LCD 116 in a circular pattern. In this case, the LCoS 114 is responsible for fine structure and/or high-spatial-frequency information delivered by the engine 110, 120, while the LCD 116 displays low-spatial-frequency information. Although this setup increases both the light efficiency and inherent contrast ratio, diffraction effects become one of the main causes of degrading the overall image performance.

### Example 3: HDR Display Engine: Two Reflective SLMs Based Modulation

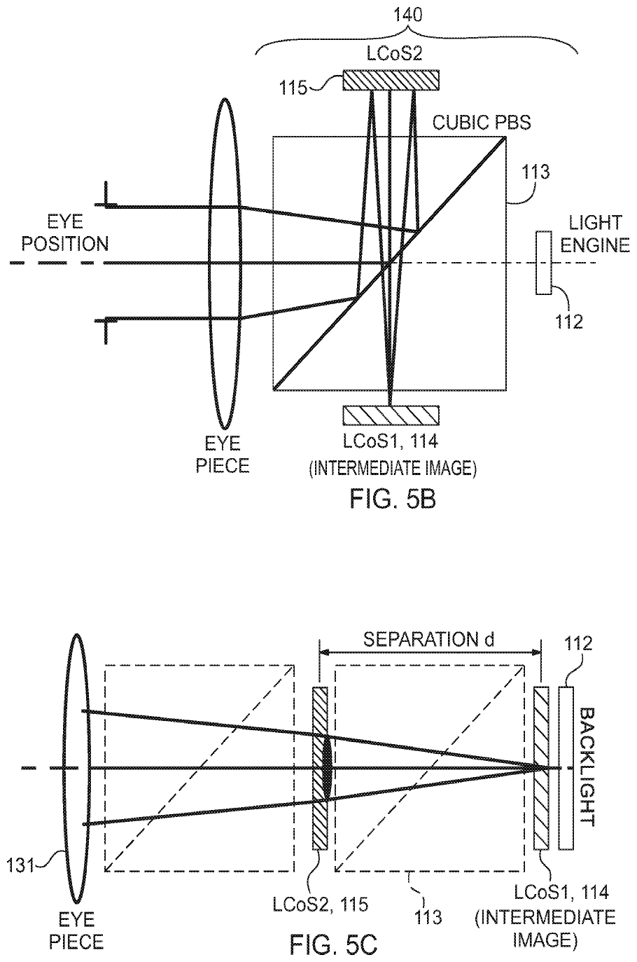

To further increase light efficiency and contrast ratio provided by multi-layer display units in accordance with the present invention, two reflective SLM layers, such as LCoS or DMD panels, can be adopted in a single HDR display. The schematic layout of the double LCoS configuration is shown in FIGS. 5A, 5B.

Taking the HDR display engine 130 of FIG. 5A as an example, p-polarized illumination light is emitted by the light engine 112, then modulated by LCoS1 layer 114. The orientation of polarization is rotated to s-polarization vector due to manipulation by the LC of the LCoS1 layer 114. The s-polarization matches the axis of maximum reflection of the PBS 113. The ray bundle reflected by the PBS 113 from the LCoS1 114 is then modulated by LCoS2 layer 115, and finally transmitted through the viewing optics 131. The HDR display engine 140 in FIG. 5B is similar, and the differences include change(s) in the position of light engine 112 and LCoS2 layer 115 to accommodate the case where s-polarized illumination is provided by the light engine 112. FIG. 5C shows the unfolded light path of optical trains of FIGS. 5A, 5B. Compared with the LCoS-LCD HDR display engines 110, 120 of FIGS. 4A-4C (which only extended a separation distance between the two SLM layers), the distance between the viewing optics 131 and the LCoS2 layer 115 is increased.

The optical path length within the HDR display engines 130, 140 of FIGS. 5A-5C is twice that of the LCoS-LCD type (of FIGS. 4A-4C), thus requiring the viewing optics 131 to have a longer back focal distance, FIG. 5C. Similarly, just as in the case of the LCoS-LCD setup of FIGS. 4A-4C, the LCoS1 layer 114 of this embodiment is capable of displaying an image with high spatial frequency, whereas the LCoS2 layer 115 is configured to only modulate light with lower spatial resolution (which is caused by the spatially-expanded pattern of illumination produced on it by a point light source; a spatially-expanded point-spread function response).

HDR Display Engine: Two Modulation Layers with a Relay System In-Between

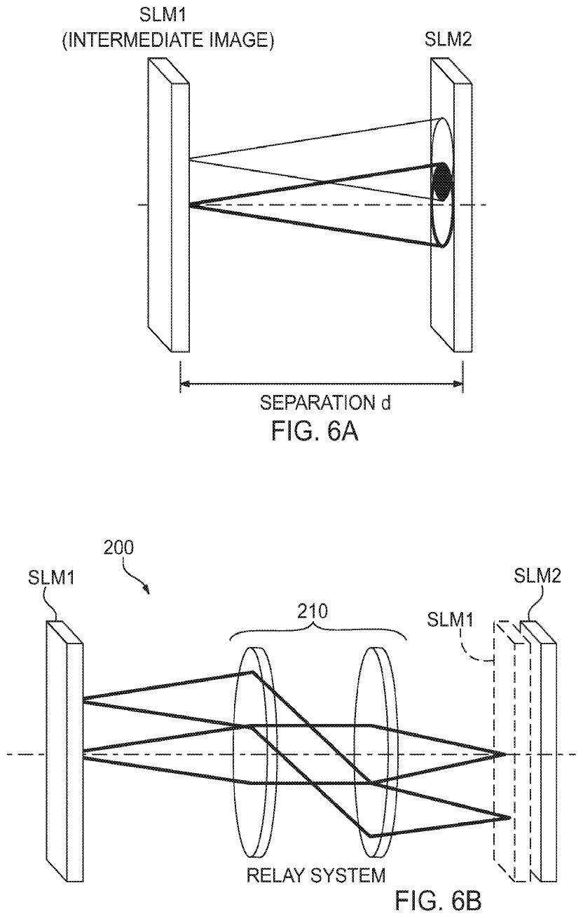

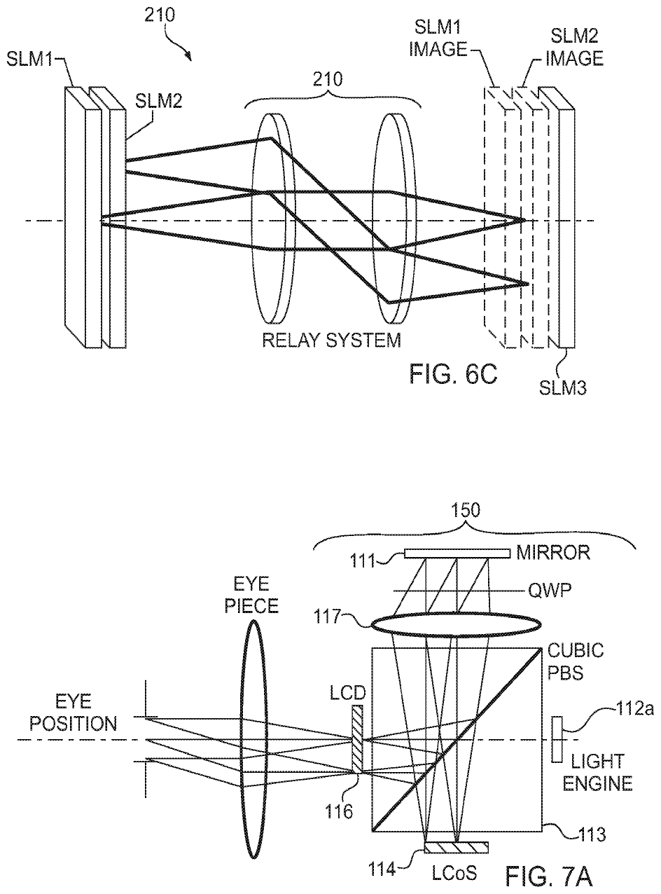

While the setups discussed above may be capable of displaying images with dynamic range that exceeds the dynamic range corresponding to 8-bits, the limitation on the maximum dynamic range value that can be achieved with these setups is imposed by the finite distance between the two SLM layers e.g., LCoS 114/LCD 116, LCoS1 114/LCoS2 115. In reference to FIG. 6A, showing the physical and optical separation d between the two SLM layers, a person of skill in the art viewing FIG. 6A would appreciate that light emanating from a pixel of the first SLM layer (SLM1) impinges onto the second SLM layer (SLM2) in a form of a spatially-diverging cone of light (a conic ray bundle) the apex of which is located at the light-emitting pixel of the first layer. In such a two-display layer system, assuming the system nominal (intermediate) image plane is located at SLM1, the conical ray bundles coming from one pixel on SLM1 forms a circular area (“footprint” of the conical bundle of rays in question) at SLM2, which area may include multiple (for example, several or tens) of pixels of the SLM2 layer. In case of the grayscale modulation, all the pixels on SLM2 contained in such circular “footprint” modulate (operate on) the light output from the same pixel of SLM1 (optionally, simultaneously). For adjacent ray bundles that originate at neighboring SLM1 pixels, the respective projected areas on SLM2 layer inevitably overlap with each other, thereby causing crosstalk, edge shadows, and/or halos in the final (modulated) image formed at SLM2.

According to an idea of the invention, and to address the problems accompanying the embodiments of the above-discussed examples, e.g., those of FIGS. 4A-5C, an optical relay system 210 is introduced between the two neighboring SLM layers, SLM1, SLM2, of the HDR display engine 200. The lateral magnification of such optical relay 210 was judiciously chosen to provide for one-to-one optical imaging and correspondence between the pixels of a first of the neighboring display layers SLM1 and the pixels of a second of such layers SLM2. For example, and in reference to FIG. 6B, when the display layers SLM1 and SLM2 are substantially identical in that both are represented by equally-dimensioned arrays of pixels of the same size, the magnification of the relay system 210 is chosen to be substantially unity, to image (with one to one correspondence) a pixel of one of the SLM1, SLM2 onto a pixel of another of these two SLM layers. If, in another example, each of the dimensions of each pixel of the SLM2 array is twice that of the corresponding pixel of the SLM2 array, the optical relay system 210 is chosen with a magnification substantially equal to 2. The relay layout shown in FIG. 6B can be extended to a plurality of modulation layers. As illustrated in FIG. 6C, two modulation layers, SLM1 and SLM2, can be imaged by a shared relay system 210 to create two conjugate images of the SLM1 and SLM2 located at, or adjacent to, the display layer, for example the SLM3. As a result, these modulator layers SLM1, SLM2 consecutively modulate the display layer SLM3 and further extending the dynamic range of the display engine 201.

To make the operation of an LC of a display layer most efficient, it may be preferred to make the optical relay system of choice to be telecentric in both image space and object space, so that—considering the geometrical approximation—the cone of light emitted by a point at SLM1 converges to one point on SLM2 and vice versa, to achieve imaging of the SLM1, SLM2 on one another across the relay system. As the result, one-to-one spatial mapping between the pixels of the display layers is achieved to avoid modulation crosstalk. As a result of operation of such telecentric configuration, when the image of the “intermediate image” formed as SLM1 is optically relayed to a plane optically-conjugate with the plane of SLM1, this also results in effective repositioning of the “intermediate image” plane towards and closer to the viewing optics, which reduces the required back focal distance (BFD) of the viewing optics.

When the physical location of the SLM2 display layer is chosen to be at a plane that is optically-conjugate with the SLM1 layer, then under the condition of one-to-one pixel imaging discussed above the overall dynamic range of the display engine containing these SLM1 and SLM2 layers that are separated by the optical relay system is maximized and equal to the maximum achievable in this situation dynamic range—that is, the product of the dynamic ranges of the individual SLM1, SLM2 layers.

In further reference to FIG. 6B, it is understood that when the physical location of the SLM2 display layer is made to deviate (be separated) from the location of the plane (SLM1 IMAGE) that is optically-conjugate to the SLM1 layer, a portion of light emanating from a given source pixels of SLM1 is relayed not only to that pixel of SLM2 which corresponds to the source pixel of SLM1, but to some neighboring pixel(s) as well (that is, the footprint of an image of a given pixel of the first display layer SLM1 formed with the relay system 210 on a second display layer SLM2 is bigger than the corresponding pixel of the second display layer SLM2, by analogy with the situation depicted in FIG. 6A). This leads to the reduction of the overall, aggregate dynamic range of the system with respect to the maximum achievable range. Accordingly, the user of the device schematically depicted in FIG. 6B can choose by how much the decided-upon value of the aggregate dynamic range varies from the maximum achievable one, and select the position the layers SLM1, SLM2 as either optically-conjugate with respect to one another planes, or not. It is appreciated that, in general, the optical relay system separating and/or imaging the neighboring display layers on one another can be chosen to be not only dioptric, but catadioptric or catoptric.

### Example 4: LCoS-LCD Display Engine with a Relay

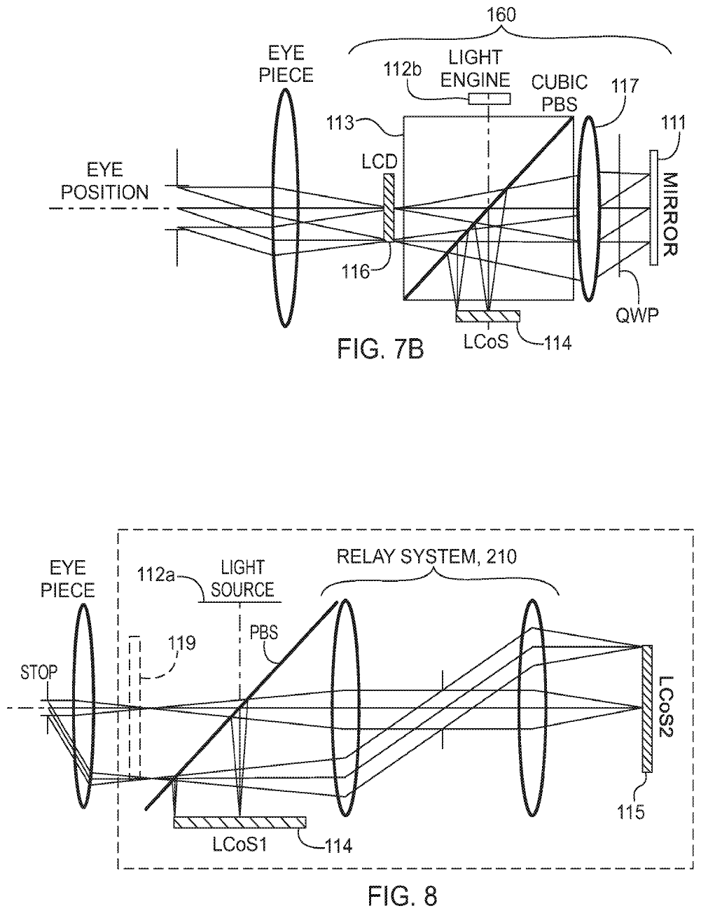

The above idea of FIGS. 6B, 6C (of optically-relaying an intermediate image from the first display layer onto the second display layer with an optical relay system 210) can be implemented in an HDR display engine that is constructed around the use of the LCoS-LCD system. FIGS. 7A, 7B illustrate two related implementations.

Just as the light engines mentioned in connection with Example 1, the light engines for Example 4 could include a complex illumination unit to provide uniform illumination, or just a single LED with a polarizer for system capacity, simplicity, low energy consumption, small size and long lifetime. For a LCoS-LCD HDR engine 150 in accordance with the present invention, a LED emitting light 112a may be manipulated to be S-polarized, so that the illumination light would be reflected by a PBS 113 and incident onto LCoS 114, FIG. 7A. Since the LCoS 114 acts as a combination of a quarter wave retarder and mirror, it converts the S-polarized incident light to P-polarized reflective light, and then the P-polarized light is transmitted through the PBS 113. To couple the LCoS 114 modulated image with a LCD 116, the ray bundle may be collimated and retro-reflected by a retroreflector, such as mirror 111. A quarter wave plate (QWP) may be inserted between the collimator 117 and mirror 111, so that by double pass through the quarter wave plate QWP, P-polarized light is converted back to S-polarization which polarization corresponds the PBS 113 high reflection axis. The modulated LCoS 114 image is finally relayed to the position of the LCD 116 and modulated by the LCD 116. The LCoS-LCD HDR engine 160 in FIG. 7B is similar to the configuration in FIG. 7A, the difference being the polarization direction of the light during transmission. The polarization direction was totally opposite between FIGS. 7A, 7B. Thus, the LED emitting light 112b is P-polarized in FIG. 7B, whereas the final ray bundle incident on LCD 116 in FIG. 7B is S-polarized. Whether the configuration of FIG. 7A or 7B is more feasible depends on the characteristics of each component in a specific embodiment, such as the LED luminescence, direction of LCD polarization filter, and so on.

By folding light path twice, compact HDR display engines 150, 160 with reflective LCoS 114 and transmissive LCD 116 as the SLM are provided in accordance with the present invention. Compared with the stacked LCDs HDR engine, such as those of FIG. 3, the luminous efficiency, highest image resolution, and system contrast ratio are improved significantly, due to the nature of reflective micro-display 114. Furthermore, the LCoS image was relayed to the position of LCD 116 in the configurations of FIGS. 7A, 7B. Compared with the stacked LCDs, which would inevitably have small gaps between two SLM, the configurations of FIGS. 7A, 7B could achieve optically zero-gap between two SLMs (LCoS 114 and LCD 116). Modulating an image at same spatial location can theoretically achieve more accurate grayscale manipulation pixel-by-pixel, which can obtain a HDR image without shadow, halo or highlight artifacts.

### Additional Examples: Two-LCoS Modulation with Image Relay

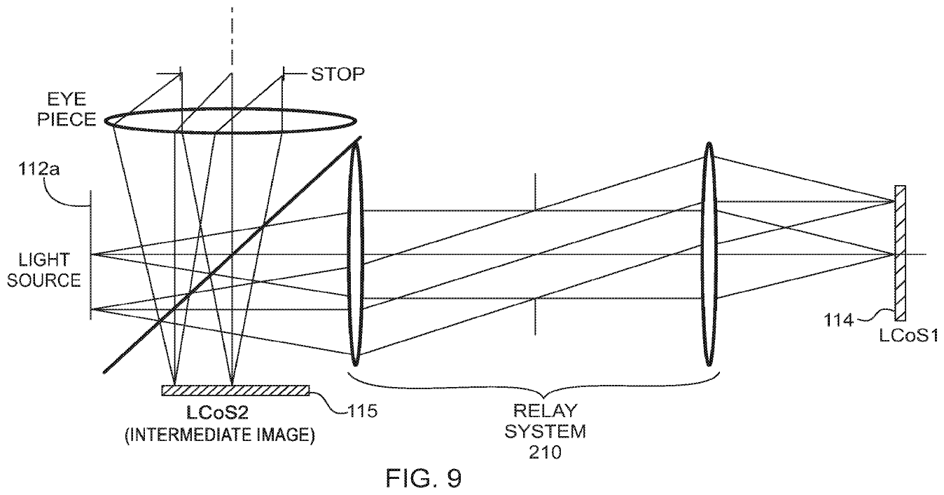

To further increase the system light efficiency, two LCoS panels with a double-path relay architecture are provided in accordance with the present invention, with FIGS. 8, 9 show different system setups. In FIG. 8, the light can pass through the relay system 210 twice. The LCoS1 114 modulates the image first, then the modulated image is relayed to the position of LCoS2 115 and modulated by LCoS2 115 again. The images of LCoS1, LCoS2 are shown by the dashed box 119. The polarization state changes after reflection by LCoS2 115, so that the final image is relayed to the left, out of the HDR display engine 170. In this configuration, LCoS2 115 displays the high frequency components whereas LCoS1 114 displays the low frequency components. Each pixel of LCoS2 115 can modulate the corresponding pixel of LCoS1 114, due to remapping structure.

The advantage of this configuration is that it does not require long back focal distance for the eyepiece design, as the intermediate image is relayed to the location out of the HDR display engine. The distance between the image and viewing optics can be as small as a few millimeters. Nevertheless, although this configuration had loose requirements for viewing optics, the relay optics needs to have superb performance, since the LCoS1 114 image needs to be reimaged twice, which introduced wavefront error twice as for image double path. Compared with all the former setups, the intermediate image quality would be not as good as the other configurations, since both SLMs image relayed once more, which would introduce even more wavefront deformation. The residual aberrations would have to be corrected by viewing optics, if the relay optics does not have an ideal performance.

FIG. 9 shows the double LCoS layout with single-pass relay. LCoS2 displays the high frequency components and LCoS1 displays the low frequency components. Different from the configuration in FIG. 8 which modulate images before the image relay, the light source was firstly mapped to LCoS1, then modulated by LCoS1 and relayed to the position of LCoS2. Compared with reimaging intermediate image like in FIG. 8, this setup avoids double passes in the relay optics, and reduced the aberration effects introducing by the relay system.

However, although system performance gets better with single relay pass, the back focal distance of viewing optics needs to be long, as intermediate image was located on LCoS2, which was inside the HDR engine. The back focal distance would highly depend on the dimension of the PBS, as well as system NA. This limited the configuration of viewing optics increased the difficulty for viewing optics design.

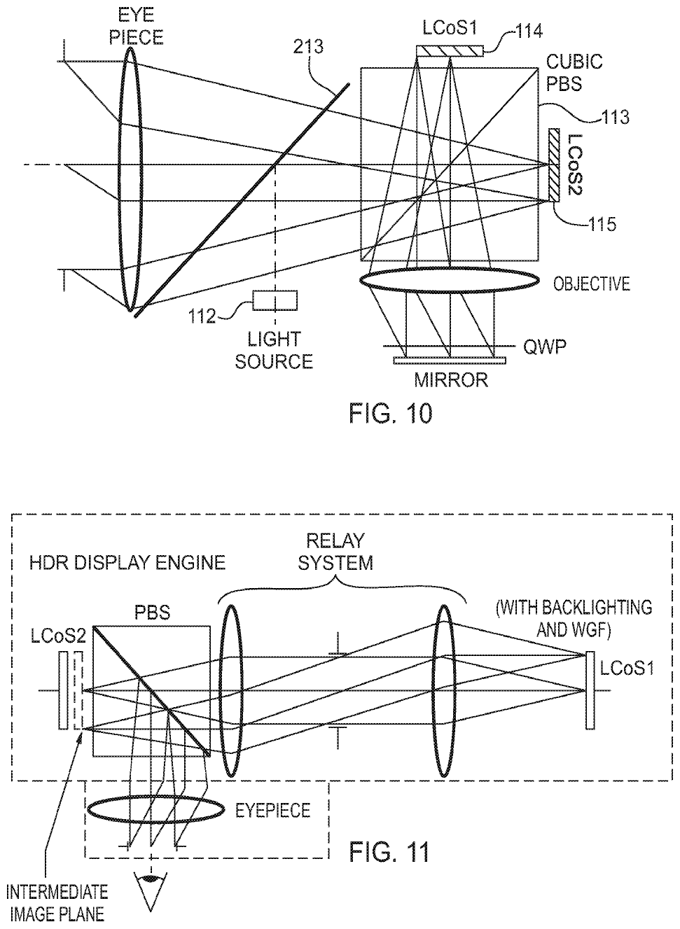

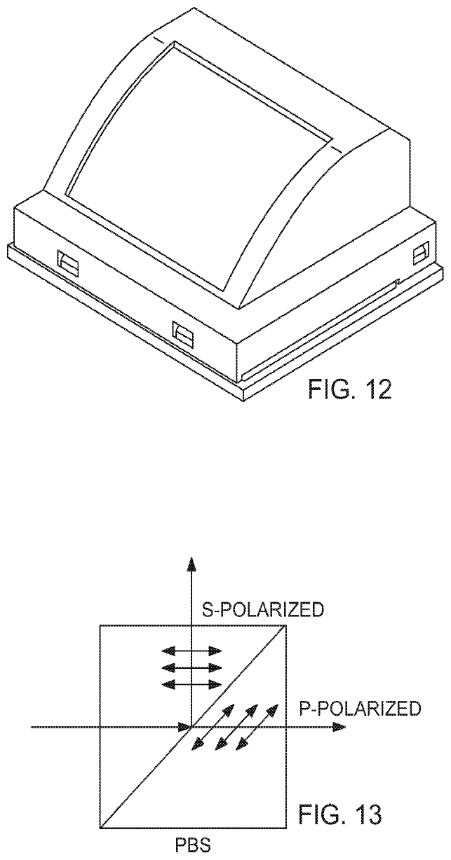

FIG. 10 shows another compact HDR display engine. Instead of using relay system between two micro-displays, this configuration used a mirror and an objective, which can be treated as a relay system folded in half. LCoS1 displays the low-resolution image, LCoS2 displays the high spatial resolution image. LCoS1 was illuminated by the light engine, whose light path was folded by another PBS 213. The light was illuminated LCoS1 firstly, then transmitted through the Cubic PBS and was collimated by the objective. It was then reflected by the PBS 113 after reflecting from the mirror and passing through the quarter wave plate. By using a half-folded relay system, LCoS1 was relayed to the location of LCoS2, so that the image was modulated twice by two LCoS respectively.

The advantage of this setup is that the system can be quite compact, because it does not only fold the light path by the Cubic PBS, it also truncates the relay system with only half of its original length. However, the disadvantage of both this configuration is that it requires a long back focal distance for the viewing optics (EYEPIECE), which as previously mentioned brings more difficulties for viewing optics design.

Table 1 summarizes the major characteristics of different HDR display engine design. We can see the tradeoff between the viewing optics BFD and HDR engine optics performance. The reason was that although introducing optics could relocate intermediate image position, it would also bring in aberrations. The light efficiency significantly improved by introducing reflective type SLMs. The modulation ability, which represents the real contrast ratio expansion, was compromised with the alignment precision. That was because minimizing the diffraction effects of microdisplays could diminish the overlapped diffraction area and improve the modulation ability, however this also required with high precision alignment with the corresponding pixel on two SLM. Overall, each design has its own advantages and drawbacks. The selection of HDR display engine for a specific HMD system should depend on the overall system specifications, like system compactness, illumination type, FOV, etc.

TABLE 1
comparison between different HDR HMD types

| | | high spatial | Low spatial | intermediate | back focal | |
|---|---|---|---|---|---|---|
| | | frequency | frequency | image | distance | light |
| basic types | FIG. # | information | information | location | requirements | efficiency |
| stacking | 4 | LCD1 | LCD2 | LCD1 | long | low |
| LCDs | | | | | | |
| LCoS-LCD | 5 | LCoS | LCD | LCoS | long | middle |
| two LCoS | 6 | LCoS1 | LCoS2 | LCoS1 | very long | high |
| LCoS-LCD | 8 | LCoS | LCD | LCD | short | middle |
| & relay | | | | | | |
| two LCoS | 9 | LCoS2 | LCoS1 | out of HDR | short | high |
| & relay | | | | engine | | |
| (double | | | | | | |
| pass) | | | | | | |
| two LCoS | 10 | LCoS2 | LCoS1 | LCoS2 | long | high |
| & relay | | | | | | |
| (single | | | | | | |
| pass) | | | | | | |
| two LCoS | 11 | LCoS2 | LCoS1 | LCoS2/out | long/short | high |
| & | | | | of HDR | | |
| integrated | | | | engine | | |
| system | | | | | | |

| | | | | optics | |
|---|---|---|---|---|---|
| | | modulation | | performance | alignment |
| basic types | FIG. # | ability | Compact-ness | requirement | requirement |
| stacking | 4 | weak | short | low | middle |
| LCDs | | | | | |
| LCoS-LCD | 5 | weak | mediate | low | low |
| two LCoS | 6 | weak | mediate | low | very low |
| LCoS-LCD | 8 | strong | mediate | middle | high |
| & relay | | | | | |
| two LCoS | 9 | strong | very long/long | very high | high |
| & relay | | | (freeform) | | |
| (double | | | | | |
| pass) | | | | | |
| two LCoS | 10 | strong | very long/long | middle | high |
| & relay | | | (freeform) | | |
| (single pass) | | | | | |
| two LCoS | 11 | strong | mediate | very high | high |
| & integrated | | | | | |
| system | | | | | |

### Implementation of a Specific Embodiment.

Before showing the example of the disclosed embodiment of the invention in detail, it is worth noting that this invention is not limited in this particular application and arrangement, because this invention is also applicable to other embodiments.
It would be helpful to show the meaning of some words used herein:
HDR—high dynamic range
HMD—head mounted display
SLM—spatial light modulator
EFL—effective focal length
FOV—field of view
NA—numerical aperture, F/#—f-number
LCoS—liquid crystal on Silicon, LCD—liquid crystal display
PBS—polarized beam splitter, AR—coating-anti-reflect coating
RGB LED—RGB light emitting diode, FLC—Ferroelectric liquid crystal
WGF—wire grid film
OPD—optical path difference
MTF—modulation transfer function

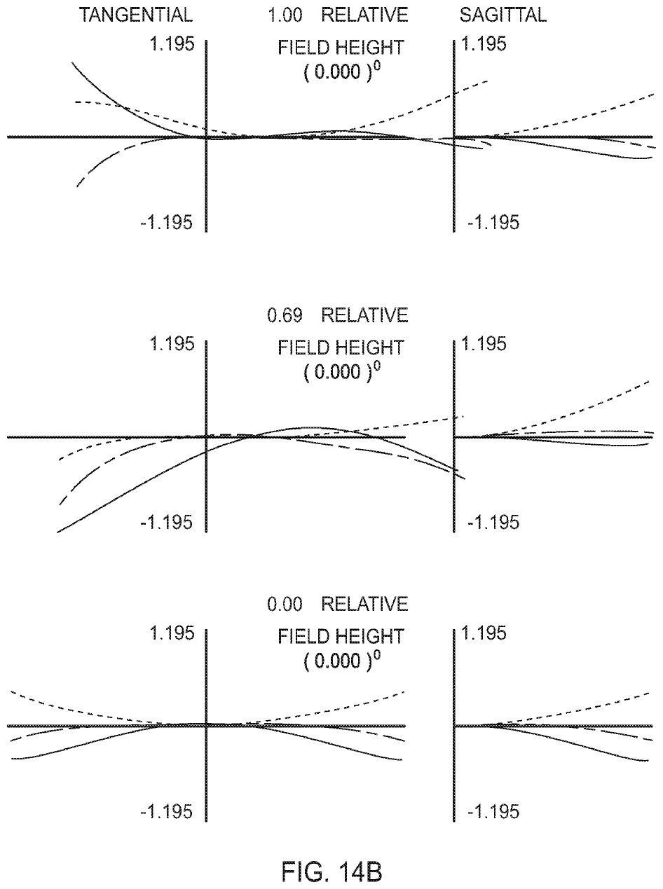

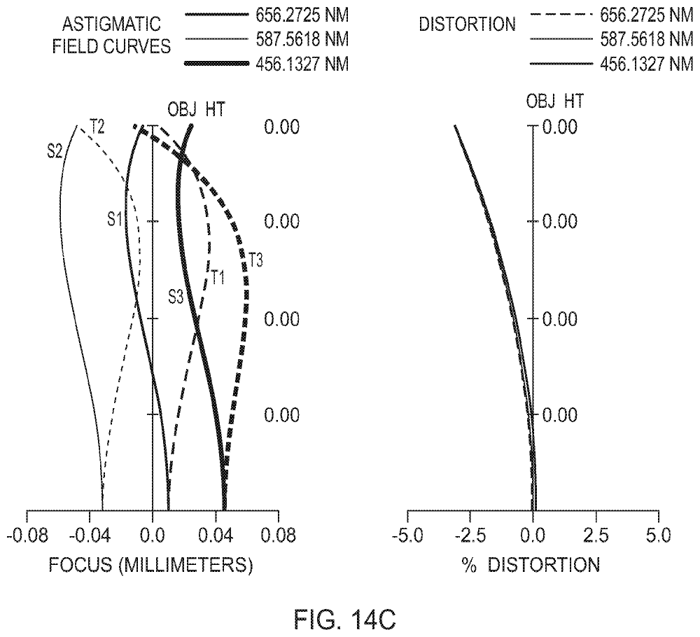

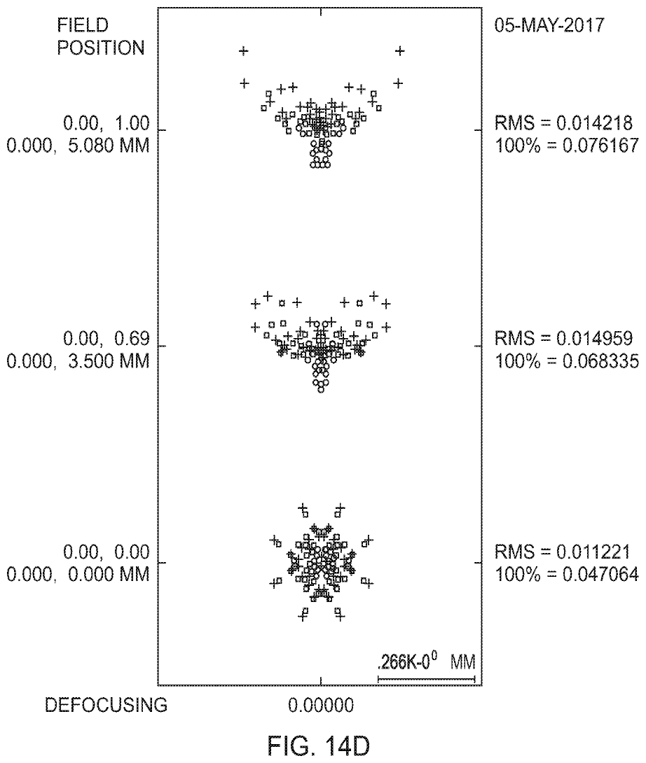

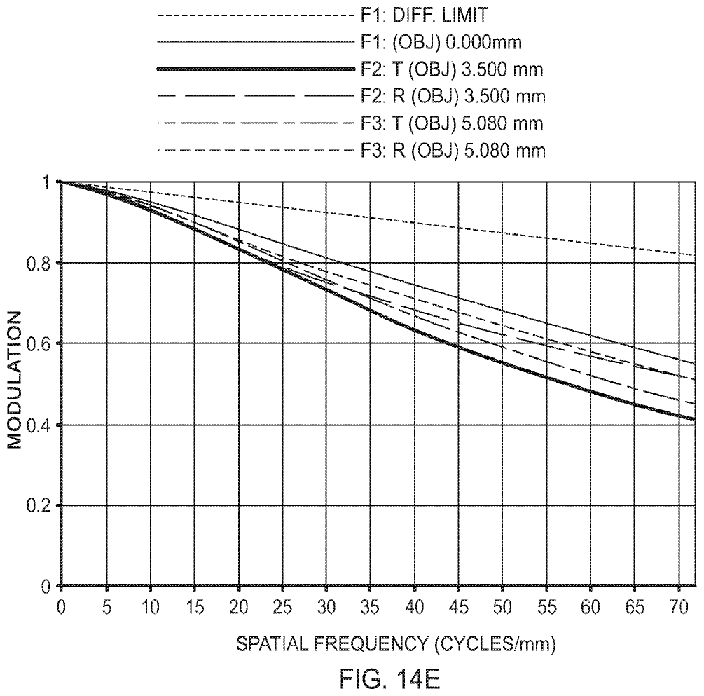

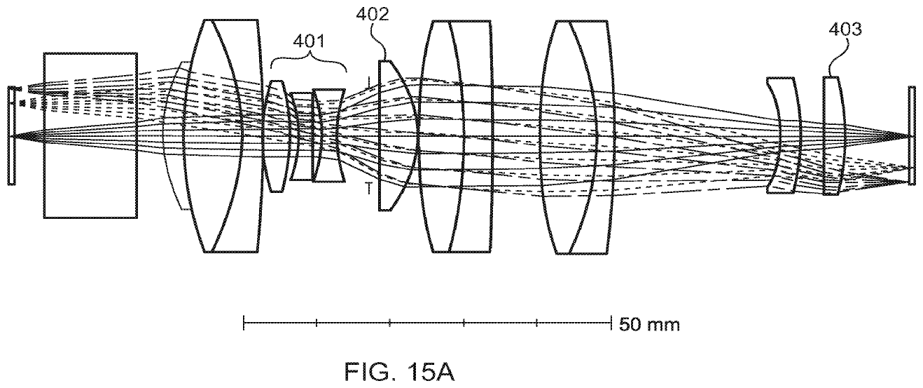

FIG. 14 shows the schematic of one proposed HDR HMD system in accordance with the present invention. The components shown in upper dashed box are the HDR display engine part, which is used to modulate and generate the HDR image. This configuration is similar to what is shown in FIG. 9, with medium relay design requirements, but needing a long back focal distance for eyepiece. What is preferable in this design to that of FIG. 9 is that the light engine (with backlighting and WGF) was built into the LCoS1, so there is no need to consider the light source path, which makes a more compact HDR engine and needs less considerations for illumination design of the HDR display engine. The bottom dash box shows the viewing optics, which could be any embodiment of viewing optics. In our system, we used an off-the-shelf eyepiece that can magnify the intermediate image modulated by two microdisplays.

TABLE 2
Specification of LCoS.
FLCoS specification

| Parameter | Specification | |
|---|---|---|
| Display technology | Ferroelectric Liquid crystal on | |
| | reflective CMOS (FLCoS) | |
| Display format | 4:3 (1280(H) × 960(V)) | |
| Display area diagonal | 10.16 | mm |
| Panel active area | 8.127 mm × 6.095 mm | |
| Pixel pitch | 6.35 | microns |

| | |
|---|---|
| Display color mode | Field sequential |
| Color input | 24-bit RGB |
| Display frame rate | 60 Hz (NTSC) |

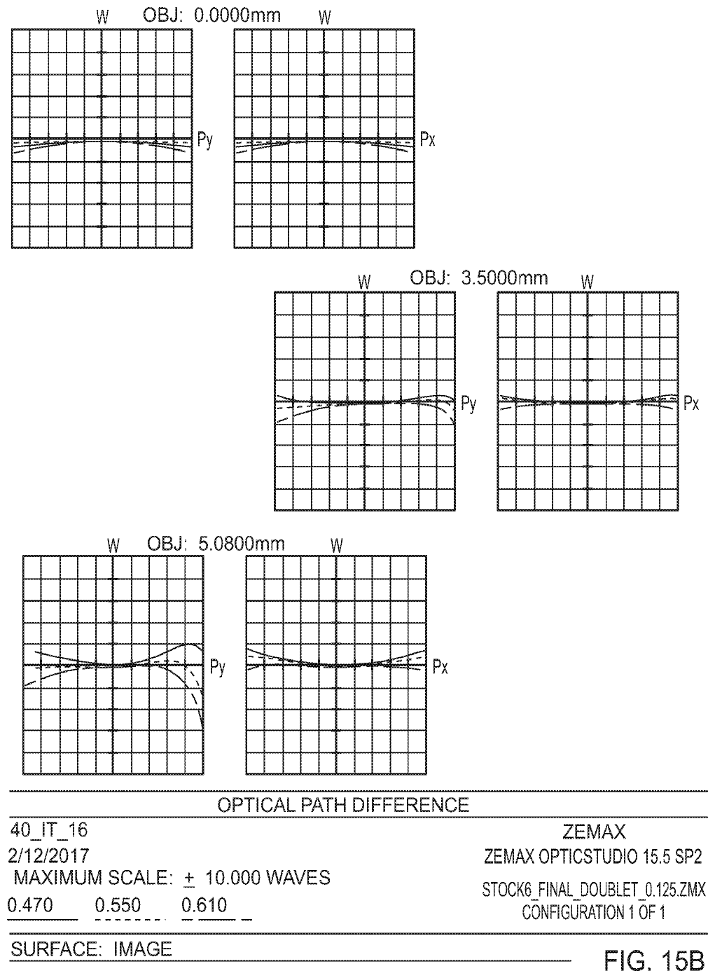

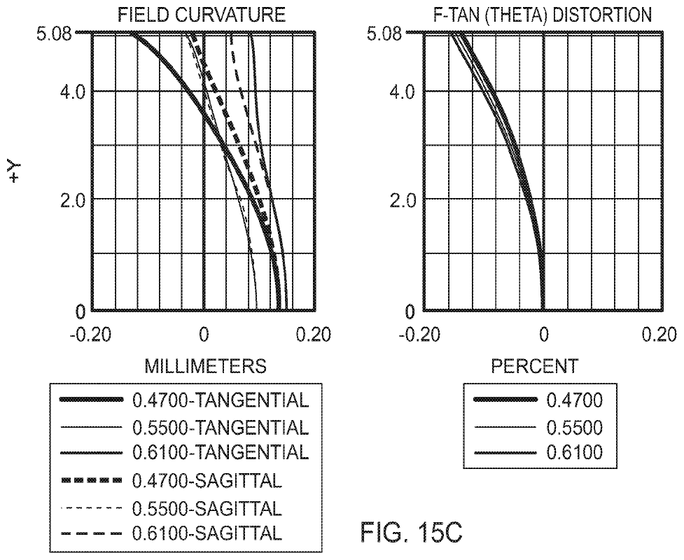

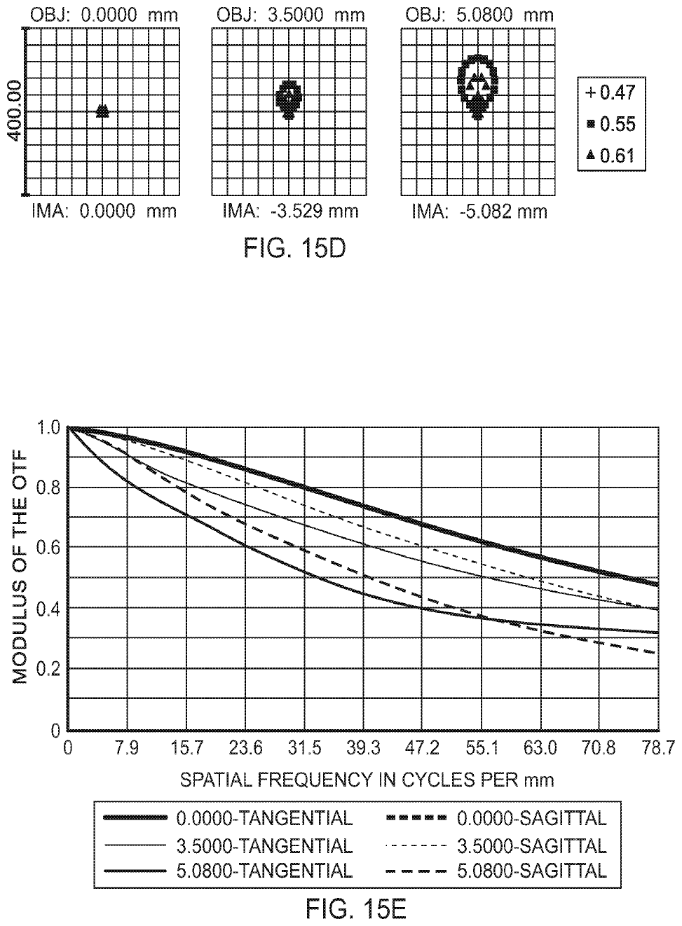

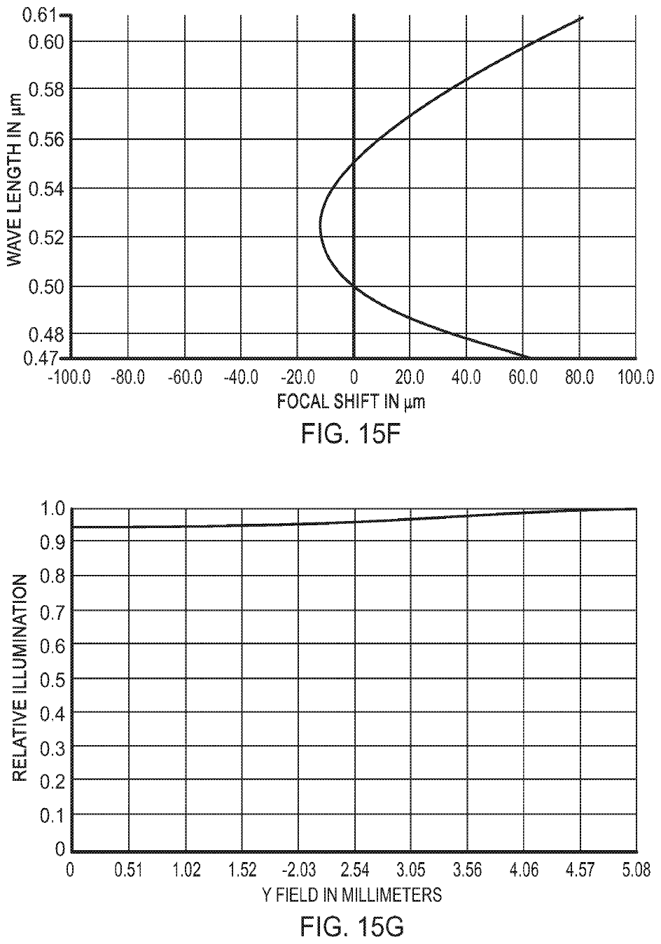

The SLMs used in this specific embodiment were FLCoS (Ferroelectric LCoS) and were manufactured by CITIZEN FINEDEVICE CO., LTD, having a Quad VGA format with resolution of 1280×960. The panel active area was 8.127×6.095 mm with 10.16 mm in diagonal. The pixel size was 6.35 um. The ferroelectric liquid crystal used liquid crystal with chiral smectic C phase, which exhibits ferroelectric properties with very short switching time. Thus, it has the capability with high-fidelity color sequential in very fast frame rate (60 Hz). A time-sequential RGB LED was synchronized with the FLCoS to offer sequential illumination. The WGF was covered at the top of the FLCoS panel with a certain curvature to offer uniform illumination and to separate the illumination light with the emerging light. FIG. 15 shows the view of the top WGF cover of LCoS1. The RGB LED was packaged inside the top cover. As the HDR display engine used two SLMs modulating a single illuminating light, only one light source was used in this system. Thus, in this design, LCoS2 was used with WGF cover removed and RGB LED disabled, whereas both the WGF cover and RGB LED were kept in LCoS1 as the system illumination. Table 2 shows the summary of LCoS specifications used in this invention.

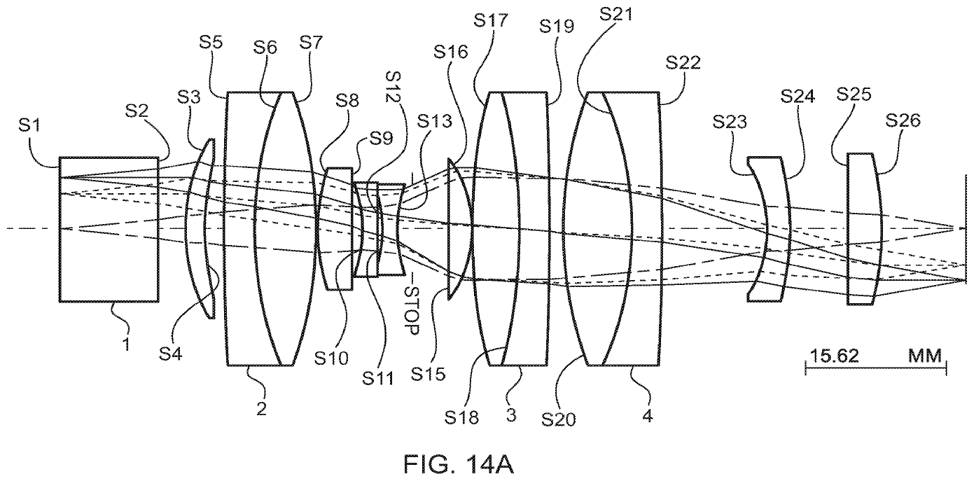

A cubic PBS was used in the design. FIG. 13 shows the schematic diagram of the cubic PBS. The PBS was employed because two polarization components of incoming light needed to be modulated separately. The PBS was composed of two right-angle prisms. A dielectric beamsplitter coating was used to split the incident beam into transmission and reflection part was coated onto the hypotenuse surface. The cubic PBS was able to split the polarized beam into two linearly, orthogonal polarized components, S- and P-polarized, respectively. S-polarized light was reflected by 90-degrees with respect to the incoming light direction, whereas the P-polarized light was transmitted without changing propagation direction. Compared with plate beam splitters which would have ghost image because of the two reflective surfaces, the cubic PBS had an AR-coating on right angle side which can avoid a ghost image, as well as have the capability of minimizing the light path displacement caused by its tip and tilt. The PBS we used in this design had an N-SF1 substrate and had the dimension of 12.7 mm. The efficiency of both transmission and reflection were over 90%, with extinction ration over 1000:1 at 420-680 nm wavelength range. Although we adopted cubic PBS in this design, other types PBS, such as wire grid type, are also applicable to this invention.

### Telecentricity of the Optical Relay System

A double-telecentric relay system with unit magnification was designed in the HDR display engine system, FIG. 11. The relay system was used to optically align and overlay the nominal image plane of the two micro-displays, LCoS1, LCoS2. Three reasons make double-telecentric an important requirement of this system: firstly, telecentricity made the light cone perpendicular to the image plane at LCoS2. In order to have the uniform illumination in the image plane position of LCoS2, telecentricity was necessary. Secondly, the performance of LCoS1/LCoS2 was restricted with its viewing angle. That means, the visual performance or the modulation efficiency was decent only within a limited viewing cone. In order to make the best use of their modulating function, both the incident light from LCoS1 and the emitting light onto LCoS2 image plane should be restricted within the viewing cone. Thirdly, the LCoS panel position might not be accurately located as practical matter. There might be a little deviation of the physical location as-built with respect to their nominal location designed. The double telecentric relay system was able to keep the uniform magnification, even when with slightly displacement.

### Considerations of Optimization

The specification of HDR display engine design can be determined based on all aforementioned analysis. The LCoS has diagonal size of 10.16 mm, which corresponds to ±5.08 mm of full field. The 0 mm, 3.5 mm and 5.08 mm object height were sampled for optimization. The viewing angle of LCoS is ±10°. The object space NA was set to be 0.125 and can be enlarged to 0.176. System magnification was set to be −1, with double telecentric configuration. The distortion was set to be less than 3.2%, and residual distortion can be corrected digitally thereafter. The sampled wavelengths were 656 nm, 587 nm and 486 nm with equal weighting factor. Table 3 shows the summary of the system design specification. Also, off-the-shelf lenses were preferred in this design.

TABLE 3
Relay system design specification

| Parameter | Specification |
|---|---|
| Object: LCoS | |
| Panel active area | 8.127 mm × 6.095 mm |
| Display area diagonal | 10.16 mm |
| Resolution | 1280 × 960 |
| Light source | RGB LED |
| Cubic PBS | |
| Cube size | ½″ (12.7 mm) |
| Material | N-SF1 |
| Other parameters | |
| NA | 0.125 to 0.176 |
| Magnification | −1 |
| Telecentricity | Double telecentric |
| Distortion | <3.2% |
| Total track | <125 mm |
| off-the-shelf lens preferred | |

FIGS. 14A-14E show the optimization results for the system. FIG. 14A was the layout of the HDR display engine after global optimization. In FIG. 14A, element 1 was the cubic PBS with N-SF1 substrate discussed above. With the initial trial, chromatic aberration appeared to be the main effect, which degraded the image quality at the initial attempts. To compensate system chromatic aberration, three off-the-shelf doublets (FIG. 14A, doublets 2, 3, 4) were preset with appropriate orientation on both sides of the stop, to balance the lateral and longitudinal focal shift of different wavelengths.

TABLE 4
Example of Design of Lens of FIG. 14A.

| Surface No. | Surface type | Radius | Thickness | Lens material |
|---|---|---|---|---|
| S1 | Sphere | Infinity | 12.700 | SF1 |
| S2 | Sphere | Infinity | 3.4143 | |
| S3 | Sphere | 13.6000 | 2.6000 | SF11 |
| S4 | Sphere | 21.9740 | 2.3963 | |
| S5 | Sphere | 161.0500 | 4.000 | NSF6 |
| S6 | Sphere | 28.4500 | 8.000 | NLAK22 |
| S7 | Sphere | −31.6900 | 0.1000 | |
| S8 | Sphere | 14.7688 | 4.5001 | 784720.257572 |
| S9 | Sphere | Infinity | 1.3093 | |
| S10 | Sphere | −11.4494 | 2.0000 | 784720.257565 |
| S11 | Sphere | Infinity | 0.6607 | |
| S12 | Sphere | −11.4298 | 2.0000 | 603420.380296 |
| S13 | Sphere | 11.4298 | 1.9007 | |
| STOP | Sphere | Infinity | 4.6687 | |
| S15 | Sphere | Infinity | 3.0547 | 516800.641668 |
| S16 | Sphere | −9.9162 | 0.0999 | |
| S17 | Sphere | 43.9600 | 6.0000 | NLAK22 |
| S18 | Sphere | −42.9000 | 4.0000 | NSF6 |
| S19 | Sphere | −392.2100 | 1.6411 | |
| S20 | Sphere | 29.0100 | 9.0000 | NLAK22 |
| S21 | Sphere | −25.5300 | 4.0000 | NSF6 |
| S22 | Sphere | −132.9200 | 13.4589 | |
| S23 | Sphere | −9.7896 | 3.0000 | CAFL |
| S24 | Sphere | −20.4225 | 7.4333 | |
| S25 | Sphere | Infinity | 4.5001 | 603421.380300 |
| S26 | Sphere | −18.8225 | 10.9931 | |

To reduce aberrations even further, two meniscus-shaped off-the-shelf singlets were also provided between the PBS and doublet 2, and between the Stop and doublet 3 respectively, see Table 4. The shape, orientation and position of the singlets were nearly mirror symmetric with respect to the aperture stop, for the sake of controlling odd aberrations, like coma and distortion, of the system. The remaining five singlet elements were set to be variable in shape, thickness and radius as shown in Table 4. For the purpose of matching with stock lenses, these elements were constrained to have the most common shapes and materials during global optimization. FIGS. 14B-14E show the system performance after global optimization. FIG. 14B shows the OPD for the three sampling fields. The OPD was left about 1.2 waves after optimization. FIG. 14C shows the residual distortion was less than 3.2% after optimization. FIGS. 14D, 14E show the spot diagram and MTF, respectively. MTF is above 40% at the cut-off frequency of 78.7 cy/mm.

FIGS. 15A-15G show the final optimization results after all the lenses (FIG. 15A 401, 402, 403) have been matched with off-the-shelf lenses. In order to match the RGB LED primary emitting wavelength and the color sensation of human visual system, 470 nm, 550 nm and 610 nm with 1:3:1 weighting factor was set to be the sampled system wavelengths. FIG. 15A element 403 was set to leave enough working distance for LCoS1 covered with a WGF. FIGS. 15B-15G show the final performance after optimization. The OPD was very flat, only with slight color aberrations at the full field. Distortion was less than 1.52% shown in FIG. 15C. FIG. 15E shows the system MTF. The MTF was beyond 25% at cut-off frequency, with the central field MTF above 45% at 78.7 cy/mm. FIG. 15F shows the chromatic change of focus. The wavelength focus shift has been well corrected. FIG. 15G shows the field-dependence relative illumination. The relative illumination was above 94% across the whole field.

### Prototype of the HDR Display Engine Configured According to an Embodiment of the Invention.

The opto-mechanical design for the HDR display engine was also proposed in this invention. A particular design in the mechanical part was a tunable aperture at the location of aperture stop. This part could be easily taken in and out of the groove with a handle. By adding a smaller or larger aperture onto this element, the system NA could be changed from 0.125 to 0.176, for seeking an optimal balance between the system throughput and performance. These mechanical parts were then manufactured by 3-D printing techniques.

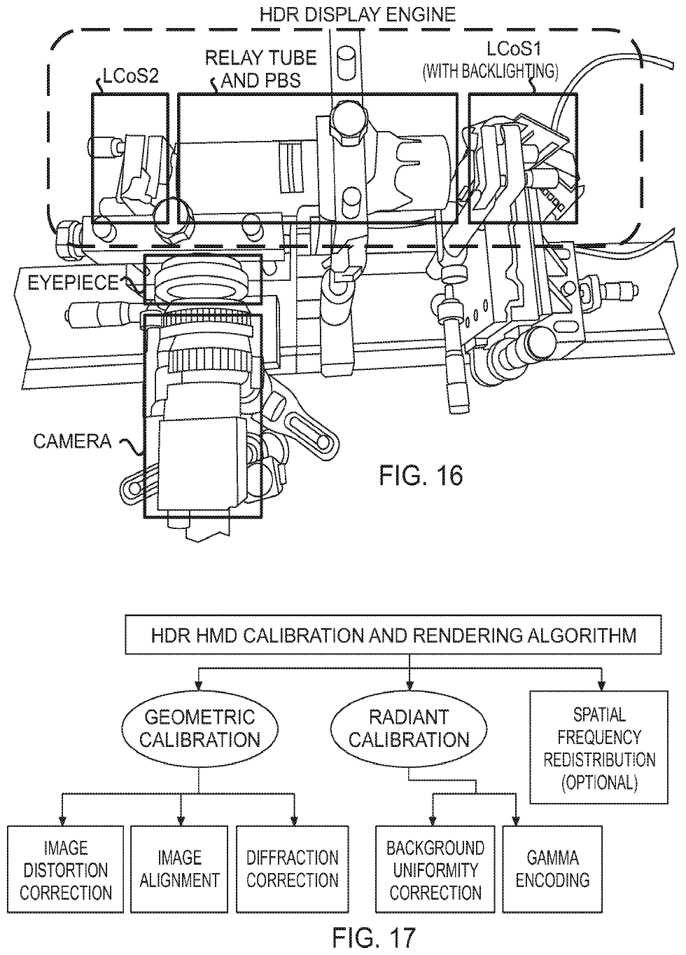

FIG. 16 shows the prototype that was constructed for the HDR display engine according to the design of FIG. 14A with the off-the-shelf lenses of FIG. 15A. Two LCoS (LCoS1, LCoS2) were fixed onto miniature optical platforms with two-knob adjustment for fine adjusting their orientations and directions. The two LCoS were set face to face with the relay tube in between. The two LCoS and relay tube were aligned on an optical rail. To test the HDR display engine performance, an off-the-shelf eyepiece was put at a side of the PBS where the reflected beam from the PBS would pass through. A machine vision camera with 16 mm focal length lens was put at the eyebox of the system for performance evaluation.

### HDR-HMD Calibration and Rendering Algorithm

After the HDR HMD system implementation, a HDR image rendering algorithm was developed, FIG. 17, and applied using the prototype of FIG. 16. To clarify the intrinsic mechanism of the system, both geometric and radiant parameters of the proposed HDR HMD should be calibrated. Geometrical calibration aims to optimize the two-image relative position in space as well as individual distortion coefficients. To get fine image modulation on the pixel-level, the two LCoS images should perfectly overlap. Although the FLCoS of FIG. 16 was only 0.4 inch, the image warp became visible after magnification by the eyepiece. In this case even small displacement could cause visible ghost image and artifacts. Since pixel-level alignment was difficult to achieve by manually tuning the relative positions of the two LCoS, a geometrical calibration was necessary to acquire the relative image position, in order to digitally correct the alignment error. What was more, the residual distortion within the system should be calibrated. Since the two microdisplay images undergo different light paths, the two images would have different distortion coefficients. Even though there were only tens of pixels distorted error, the combining image performance could be degraded severely at the edge of image, due to the displacements between two LCoS corresponding pixels.

The calibration and rendering algorithm of radiant parameters is performed to pursue proper radiance distributions and pixel values. As HDR image was actually stored absolute illumination value rather than grayscale level, the display tone mapping curve needs to be calibrated to properly displayed the image. Furthermore, due to the optics and illumination distribution, there might be some inherently uneven radiance distribution, which should be measured and corrected a priori. What was more important, the HDR raw image data should be separated into two individual images shown on two FLCoS. Based on the configuration analysis of the prototype of FIG. 16, the two SLMs should contain different image details and spatial frequencies that were determined by the system configurations. In order to properly display and reconstruct desired images, a rendering algorithm was introduced as follows.

### Geometric Calibration

Although two LCoS of the prototype of FIG. 16 were fixed on tip-tilt platforms with 3-dimensional translation stages for fine adjusting their position and orientation, it was practically not possible to overlay each pixel in the LCoS1 nominal image plane with the position of LCoS2. The displacement between each pixel in the two image planes would result in significant image quality degradation, especially for the high spatial frequency information. Even if the two LCoS image planes could be perfectly overlapped, the edge pixel on the two LCoS would still have significant displacement. This was because before magnifying the intermediate HDR image by the eyepiece, the two LCoS images were generated with different light paths. The LCoS1 image passed through the relay system and was reimaged twice. This caused the two LCoS images to have different distortion coefficients on the nominal image plane, and made image alignment even harder. In this case, not only the image quality would be degraded, the command level of each pixel cannot be appropriately distributed to a modulated dynamic range as expected.

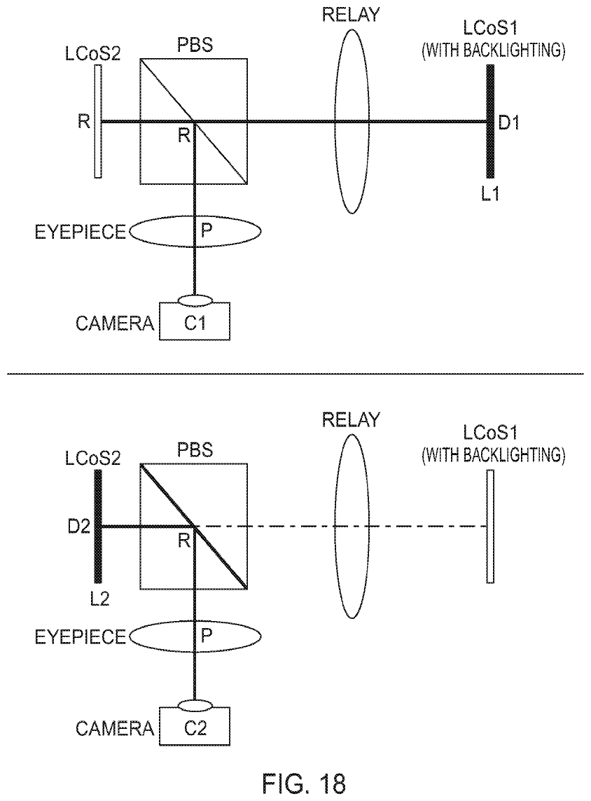

To fully understand the how the image was distorted and deviated, we should firstly determine the image forming light path for each LCoS. FIG. 18 shows the light path for each LCoS image formation. If we simplified and symbolize each optical element as a matrix, so every time when light pass through one element, we multiplied its matrix to the incoming image as it had made some changes on the images. Then each LCoS image forming procedure can be expressed as an equation:

C₁=P₁RRD₁L₁ and C₂=P₂RD₂L₂ (1)

where L₁ and L₂ were the undistorted original image; D was the distortion introduced during the whole image forming light pass; R was the reflection. The reflections need to be considered due to parity change of the image; P was the projection relation from the 3-D global coordinates to the 2-D camera frame. C₁ and C₂ were the image captured by camera.

To optically overlap C₁ and C₂, the two equations above should be algebraic equivalent. We could conclude that besides considering parity change caused by reflection, the projection matrixes P and distortion coefficients D of each LCoS should be calibrated, for obtaining the 2-D projection equivalence.

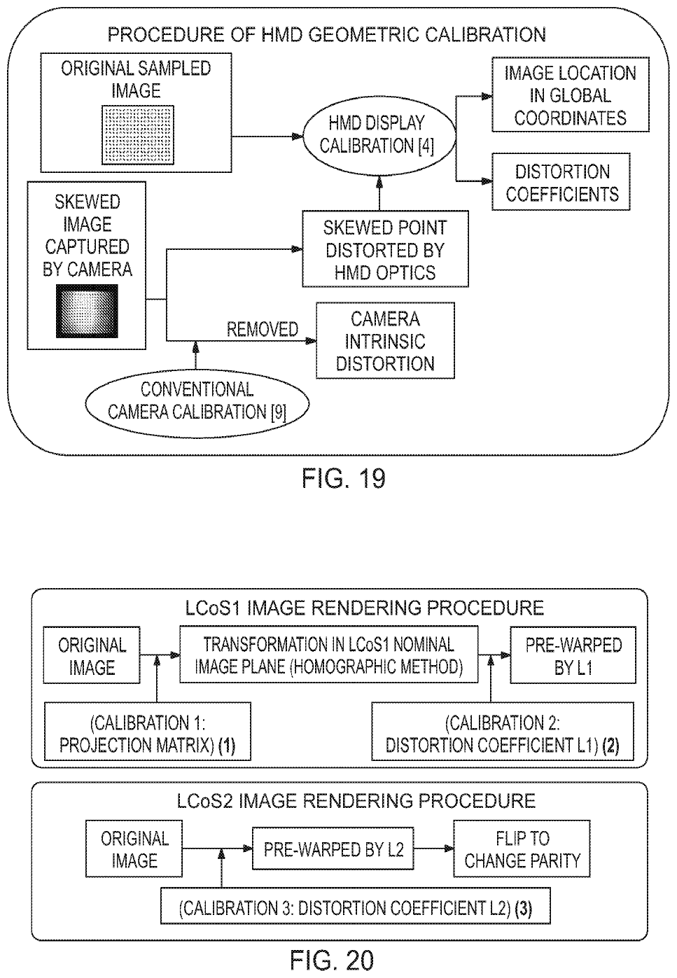

The geometric calibration was based on the HMD calibration method of Lee S and Hua H. (Journal of Display Technology, 2015, 11(10): 845-853). The distortion coefficients and intermediate image positions were calibrated based on a machine vision camera placing at the exit pupil of the eyepiece where should also be the position of viewer's eyes. To obtain the relationship between original image point and corresponding point distorted by HMD optics, the camera intrinsic parameters and distortions should be calibrated first, for the sake of removing influence brought by camera. We calibrated these parameters by using the camera calibration toolbox discussed by Zhang Z. (Flexible camera calibration by viewing a plane from unknown orientations[C]//Computer Vision, 1999. The Proceedings of the Seventh IEEE International Conference on. Ieee, 1999, 1: 666-673), with taking a series of unknown orientation checkerboard patterns, extracting the corner point positions and fitting with expected values. The rigid body transformation should be tenable between the original sampled image and the distorted image after eliminating the effects of the camera distortion. The distortion coefficients and image coordinates could then be estimated based on the perspective projection model. The process of the HDR HMD geometric calibration is shown in FIG. 19. The targeted image used here was a 19*14 circular dots pattern which sampled the image with equally space across the whole FOV. The skewed image was captured by camera, then each central point of the dots was extracted as a sampling field to estimate the two nominal images plane distances, orientations, radial and tangential distortion coefficients. Those calibrated parameters were saved for the aligning algorithm, which shown in the following.

### Image Alignment Algorithm

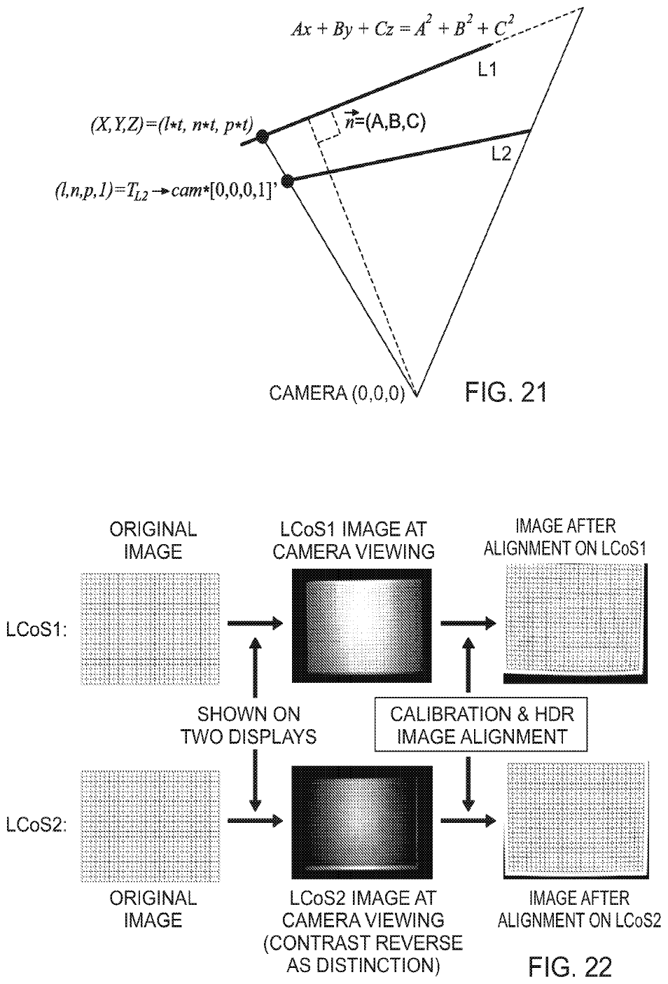

In order to get the viewing image perfectly overlapped, the HDR image alignment algorithm should be adopted to pre-warp original images digitally, based on the calibrated results. The flow chart of how the algorithm works is shown in FIG. 20. Two geometric calibrations (FIG. 20: (1) and (2)) for LCoS1 image were required during this image alignment process, if we used LCoS2 image as the reference image plane. LCoS1 image should be firstly projected to the image position of LCoS2, so that both of the displayed image would look like locating at the same position with same orientation relative to the projection center, which would also be the camera viewing position, shown in the FIG. 21 at original point.

To correct the projection position, the pinhole camera model was used for simplicity. In order to overlap projected images on camera position, the transformation matrix was derived based on at least four projection points in global coordinate system. For each LCoS2 point (l,n,p), the corresponding projection point on LCoS1 (x_{g}, y_{g}, z_{g}) could be calculated by the parametric equation:

$$\begin{matrix}\{ \begin{matrix}{x}_{g} = l * t \\ {y}_{g} = n * t \\ {z}_{g} = p * t\end{matrix} & ( 2 ) \\ t = \frac{{A}^{2} + {B}^{2} + {C}^{2}}{Al + Bn + Cp} & \end{matrix}$$

Where (A, B, C) was the normal direction of LCoS1 with respect to camera. t was the projection parameter.

In the 2-D projection plane, the original and the projection position was associated by the projective transformation matrix H:

$$( \begin{matrix}{x}^{′} \\ {y}^{′} \\ 1\end{matrix} ) = ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) ( \begin{matrix}x \\ y \\ 1\end{matrix} ) \qquad ( 3 )$$

Note that (x,y) and (x′,y′) are the local coordinates on the projection plane. Then for homogeneous solution of the homography, the elements of the 3 by 3 transformation matrix H should be calculated by.

$$( \begin{matrix}{x}_{1} & {y}_{1} & 1 & 0 & 0 & 0 & - {x}_{1}^{′} {x}_{1} & - {x}_{1}^{′} {y}_{1} \\ 0 & 0 & 0 & {x}_{1} & {y}_{1} & 1 & - {y}_{1}^{′} {x}_{1} & - {y}_{1}^{′} {y}_{1} \\ {x}_{2} & {y}_{2} & 1 & 0 & 0 & 0 & - {x}_{2}^{′} {x}_{2} & - {x}_{2}^{′} {y}_{2} \\ 0 & 0 & 0 & {x}_{2} & {y}_{2} & 1 & - {y}_{2}^{′} {x}_{2} & - {y}_{2}^{′} {y}_{2} \\ {x}_{3} & {y}_{3} & 1 & 0 & 0 & 0 & - {x}_{3}^{′} {x}_{3} & - {x}_{3}^{′} {y}_{3} \\ 0 & 0 & 0 & {x}_{3} & {y}_{3} & 1 & - {y}_{3}^{′} {x}_{3} & - {y}_{3}^{′} {y}_{3} \\ {x}_{4} & {y}_{4} & 1 & 0 & 0 & 0 & - {x}_{4}^{′} {x}_{4} & - {x}_{4}^{′} {y}_{4} \\ 0 & 0 & 0 & {x}_{4} & {y}_{4} & 1 & - {y}_{4}^{′} {x}_{4} & - {y}_{4}^{′} {y}_{4}\end{matrix} ) ( \begin{matrix}{h}_{11} \\ {h}_{12} \\ {h}_{13} \\ {h}_{21} \\ {h}_{22} \\ {h}_{23} \\ {h}_{31} \\ {h}_{32}\end{matrix} ) = ( \begin{matrix}{x}_{1}^{′} \\ {y}_{1}^{′} \\ {x}_{2}^{′} \\ {y}_{2}^{′} \\ {x}_{3}^{′} \\ {y}_{3}^{′} \\ {x}_{4}^{′} \\ {y}_{4}^{′}\end{matrix} ) \qquad ( 4 )$$

where h₁₁˜h₃₂ are the elements transformation matrix and h₃₃=1. Subscripts for (x,y) and (x′,y′) denoted for different sampled points. They all denoted the local coordinates in the projection plane, and could be calculated by coordinate transformation from their corresponding global coordinates. By using the transformation matrix and adopting appropriate interpolation method, the projected images can be rendered, as the image shown in the right column of FIG. 22, where LCoS1 image was transformed to the location of LCoS2 by homography.

The second camera-based calibration was operated after homography (FIG. 20: (2)). It aims to get the radial and tangential distortion coefficients with respect to the LCoS1 current projected image location. The projected LCoS1 image would then be pre-warped with respect to its current position by the calibrated distortion coefficients. To increase the alignment accuracy, some local adjustment could be executed by residual error analysis.

Since LCoS2 of FIG. 16 was set to be the viewing reference, the calibration and alignment algorithm was straightforward, with only one calibration and pre-warp process for the distortion correction, as shown in FIG. 20: see (3).

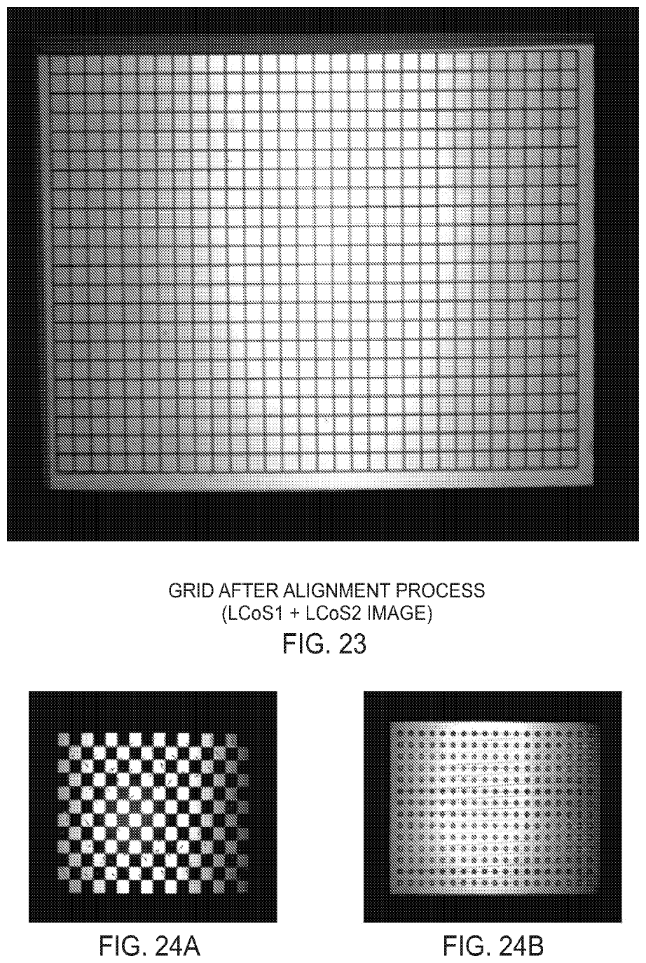

FIG. 22 shows an example of how this algorithm works for each LCoS image of the prototype. The image we used for evaluating the alignment was an equally spaced uniform grid (FIG. 22 left column), for the sake of observing misalignment across the whole field. When the grids were shown onto the two LCoS respectively, we observed a severely distorted grid on each microdisplay, as the camera captured image in FIG. 22, 2^{nd} column. Moreover, if LCoS2 image was set as the reference image position, the LCoS1 image showed slight displacement and tilt when projecting to the camera viewing position. The combining of the two images would result in a severely blurred and deviated HDR image as for the camera viewing. (FIG. 22, 3^{rd} column) shows the post-processing images after processed with HDR image alignment algorithm. The LCoS1 image was deviated from its original location and both images were pre-distorted for distortion correction. FIG. 23 shows the grid image aligning results when displaying the post-process images onto two displays of the prototype simultaneously. By adopting HDR image alignment algorithm, the two girds projected to the camera viewing can be overlapping with nearly little visible error.

### Error Analysis

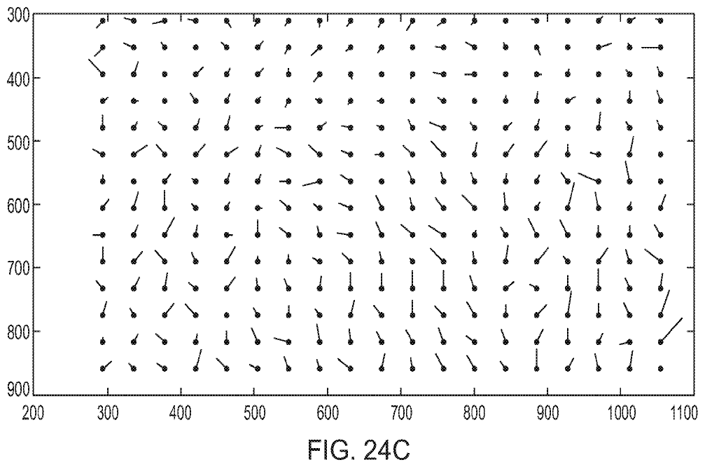

The residual alignment error of the prototype should be analyzed for evaluating the aligning performance. To do this, the local image projected coordinates on the camera view should be appropriately sampled and extracted for comparison. In this experiment, either the checkerboard pattern or circular pattern could be used in the error analysis, as shown in FIGS. 24A and 24B, respectively. With the fixed camera viewing position, the projected images were captured both for LCoS1 or LCoS2, and then the coordinates of the corner or the weighted center were extracted by the image post-processing. Both the numerical and vectoral error could be calculated and plotted based on the relative displacement of the extracted pixel position. We used a checkboard pattern with 15*11 samplings and a circular pattern with 19*14 samplings across the whole field as the sampled target in FIG. 24A, 24B, respectively. FIG. 24C shows the plot of residual error for the circular sampling position in FIG. 24B. The vector was pointed from L1 sampling position to L2. Note that the vectors in FIG. 24C only denote the relative magnitude of the displacement, not the absolute value. By analyzing alignment error distributions and directions across the whole field of view, some local refinement could be done based on the residual error analysis.

### HDR Image Source and Generation

Before discussing the radiance calibration and rendering algorithm for HDR HMD, it should be noticed that the normal image formats with 8-bit depth no longer offer wide enough dynamic range for rendering a HDR scene on the proposed HDR HMD, which have the capability to reproduce the image with 16-bit depth. Thus, the HDR imaging technique should be employed for acquiring a 16-bit depth raw image data. One common method to generate a HDR image is to capture multiple low dynamic range images with same scene but at different exposure time or aperture stop. The extended dynamic range photograph is then generated by those images and stored in HDR format, the format that stores absolute luminance value rather than 8-bit command level. The HDR images used in following were generated based on this method. The HDR image production procedure is not the main part of the invention, thus will not mentioned more in detail.

### Radiance Map Calibration

In order to display HDR images with desired luminance, the tone response curve for each microdisplay should be calibrated, for converting the absolute luminance to pixel values. A spectro-radiometer was used in this step, which can analyze both spectral and luminance within a narrow incident angle. It was settled at the center of exit pupil of the eyepiece as to measure the radiance when viewing each microdisplay. In order to get the response plots for each LCoS, a series of pure colored red, green and blue targets with equal grayscale differences were displayed on each microdisplay as the sampled grayscale values for the measurements. The XYZ tristimulus values for each grayscale could be calibrated by a spectroradiometer, and then translated to the value of RGB, and normalized to the get the response curve for each color, based on the equation:

$$\begin{matrix}{v}_{r} ( {R}_{i} ) = \frac{{X}_{{R}_{i}} - {X}_{0}}{{X}_{{R}_{max}} - {X}_{0}} & ( 5 ) \\ {v}_{g} ( {G}_{i} ) = \frac{{Y}_{{G}_{i}} - {Y}_{0}}{{Y}_{{G}_{max}} - {Y}_{0}} & \\ {v}_{b} ( {B}_{i} ) = \frac{{Z}_{{B}_{i}} - {Z}_{0}}{{Z}_{{B}_{max}} - {Z}_{0}} & \end{matrix}$$

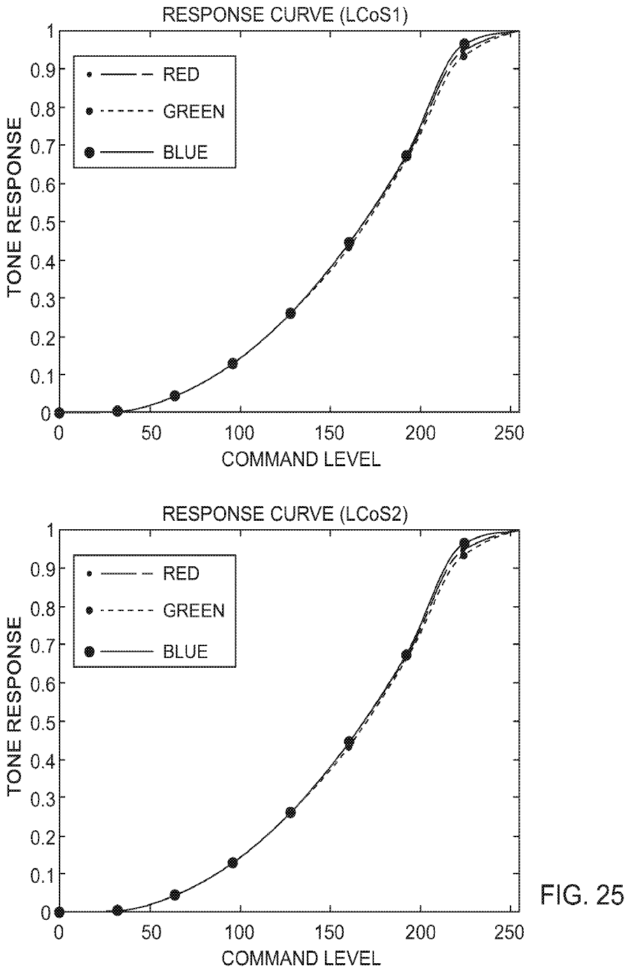

To eliminate the effects of the background noise, the tristimulus value (X₀,Y₀,Z₀) corresponding to [R G B]=[0 0 0] should be calibrated and subtracted from each data, as per equation 5. The response curves for two SLM were calibrated separately, with target images shown on the testing LCoS, while keeping another with total reflection (maximum value [R G B]=[255 255 255]). The tone response curve was then interpolated using piecewise cubic polynomial by the sampled values, as shown in FIG. 25. It is clearly to see that the display response was not a linearly relation, but with a gamma exponential greater than 1.

### HDR Background Uniformity Calibration

In order to render desired image grayscale, another requisite calibration was the HMD intrinsic field-dependent luminance calibration. Due to effects of optics vignetting, camera sensation, and backlighting non-uniformity, the image radiance may not be evenly distributed over the whole field of view. Even showing uniform values onto microdisplays, it is practically not possible to see uniform brightness across the whole FOV because of those internal artifacts. Therefore, all these miscellaneous artifacts should be corrected during the image rendering procedure.

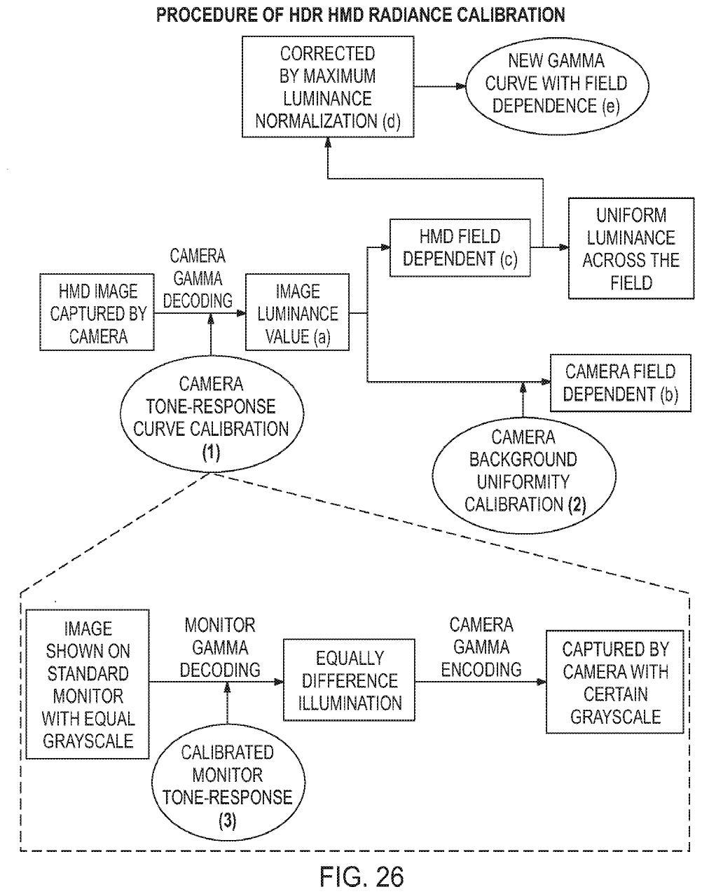

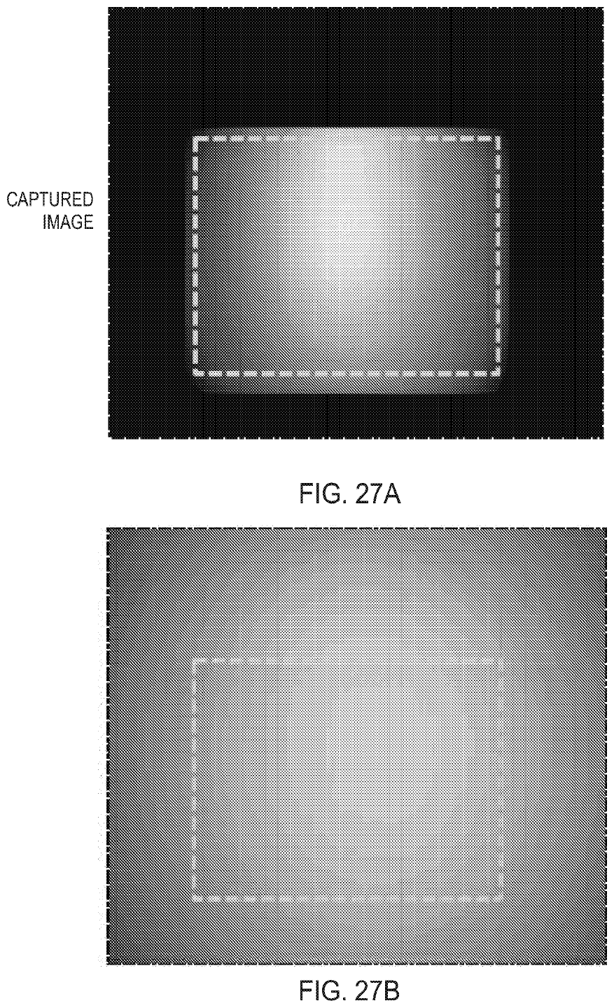

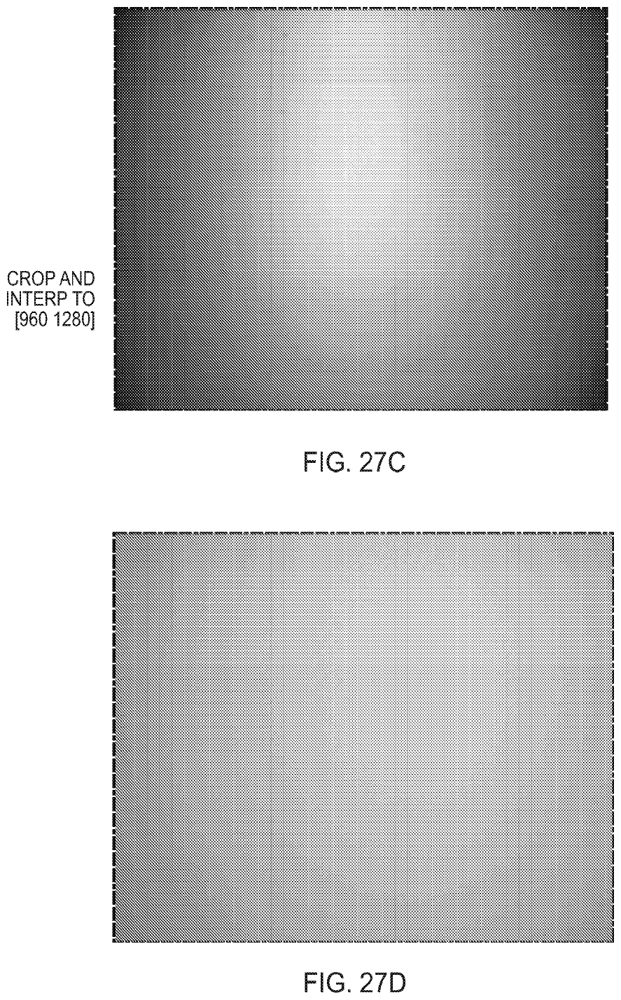

Directly measuring the radiance over the whole field was not feasible since the acceptance angle for the spectroradiometer was narrow and it was hard to accurately control its direction during measurements. Thus, a camera-based field-dependence radiance calibration was adopted. The procedure is shown in FIG. 26 at steps (1) and (2). To accurately calibrate the radiance distribution, camera intrinsic influences should be calibrated and subtracted first. The camera response curve was calibrated by a standard monitor whose radiance map has already been measured, as per the procedure shown inside the dashed line of FIG. 26. By capturing a series of uniform background scenes with equal radiant difference, the camera tone response can be accurately calibrated. It was used for camera gamma decoding, after which the absolute luminance value for the captured HMD image was recovered, FIG. 27A. It was important to know that the camera should not saturate over the entire field. The uneven image radiance distribution was due to two components: from the camera intrinsic (FIG. 27B) and from HMD intrinsic (FIG. 27C). To remove the camera dependents, the second calibration (FIG. 26: (2), measuring camera background uniformity) was taken, as shown in FIG. 27B, to take a picture of standard monitor which was displaying uniform command level [255 255 255] across the whole field. To get the relative luminance for each pixel, both the camera background and camera captured HMD background were cropped to the region where HMD field was actual covered, like the region in FIGS. 27A, 27B shown by the dashed line. Both of the areas of FIGS. 27A, 27B were then interpolated to the display resolution for pixelated analyzing the relative luminance, which shown in FIGS. 27C, 27D. By dividing original luminance value map (FIG. 27C) by the camera field dependent map (FIG. 27D), the pixelated HMD relative luminance distribution was obtained.

Before uniformity correction (FIG. 27D), we firstly need to define the normalization factor f(x,y) as the ratio of the luminance value at a pixel count(x,y) to the maximum luminance value across the whole field. The background correction was achieved by truncating the tone response curve with normalization factor and scaling the rest of it to 1. FIG. 27D shows some sampled points tone response curve after the uniformity correction. Instead of having identical response curve across the whole field, the tone mapping curve after uniformity correction was highly dependent on the pixel position, owing to digitally compensated for the radiant field differences.

However, it should be noticed that the uniformity correction sacrificed the central field pixels command level to improve the uniformity at the SLM panel (or panel display). The HDR engine might lose its effectiveness at some extent, if the command level were truncated too much. Thus, in the algorithm, a clipping factor may be provided to the user to select appropriate tradeoffs between uniformity and system dynamic range.

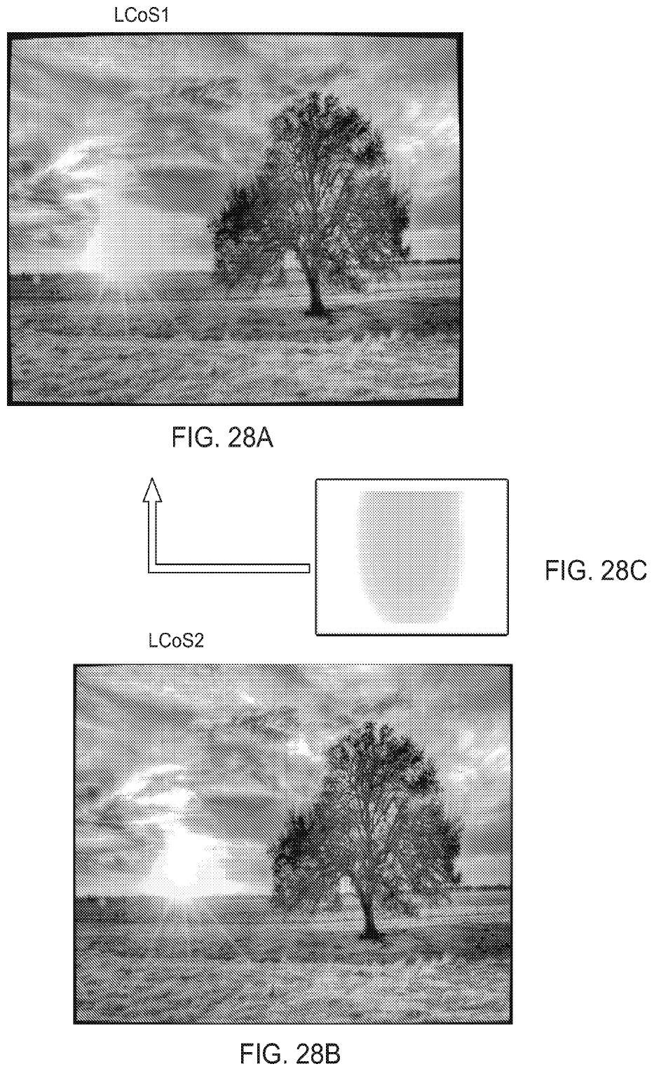

FIG. 28C shows a result for the background uniformity correction. It was easily understood that the central field was dimmer after the correction, as to compensate radiance lost at the corner by vignetting and illumination. FIGS. 28A, 28B show a pair of rendered image displayed on LCoS1 and LCoS2 after processing both alignment and radiance rendering algorithm. Uniformity has been corrected on the LCoS1 image as shown in FIG. 28A. The center of FIG. 28A has a shadow area compared with uncorrected scene in FIG. 28B. We can see the background uniformity correction was more like a filter or a mask. FIG. 28C is applied to the original image to compensate the uneven distributed backlight with the incorporated gamma encoding process. After the whole uniformity correction process, the image now becomes more uniform and real.

### HDR Image Radiance Rendering Algorithm

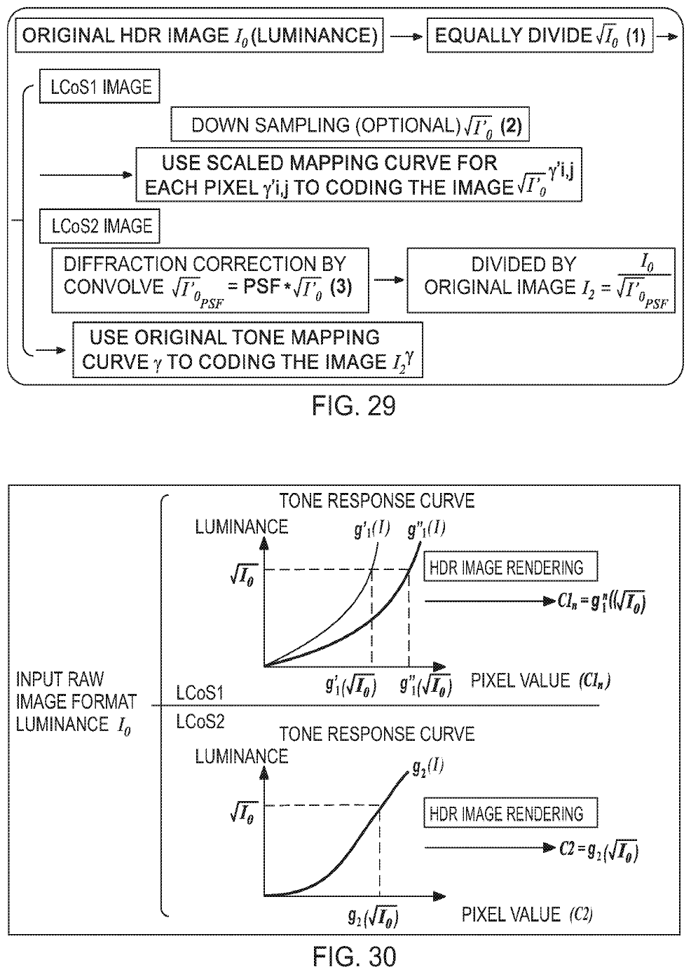

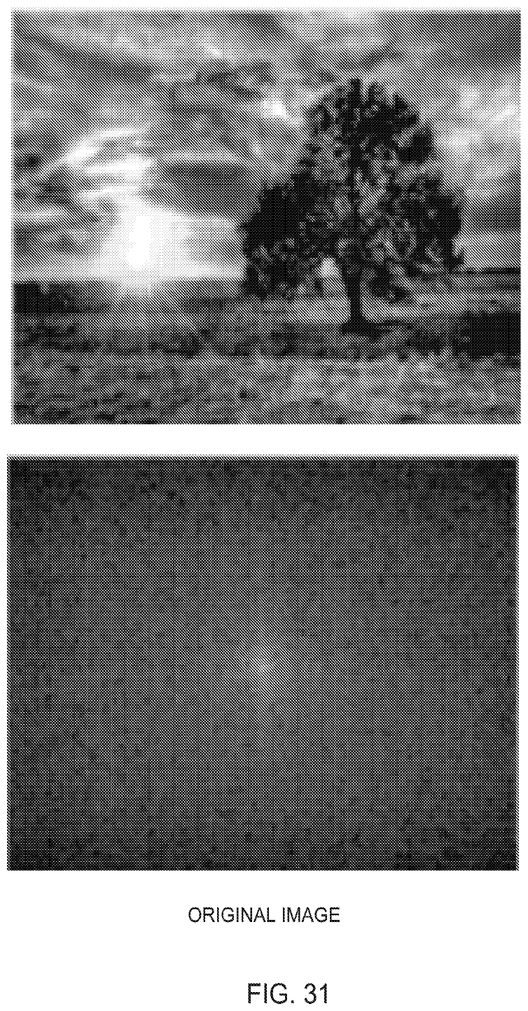

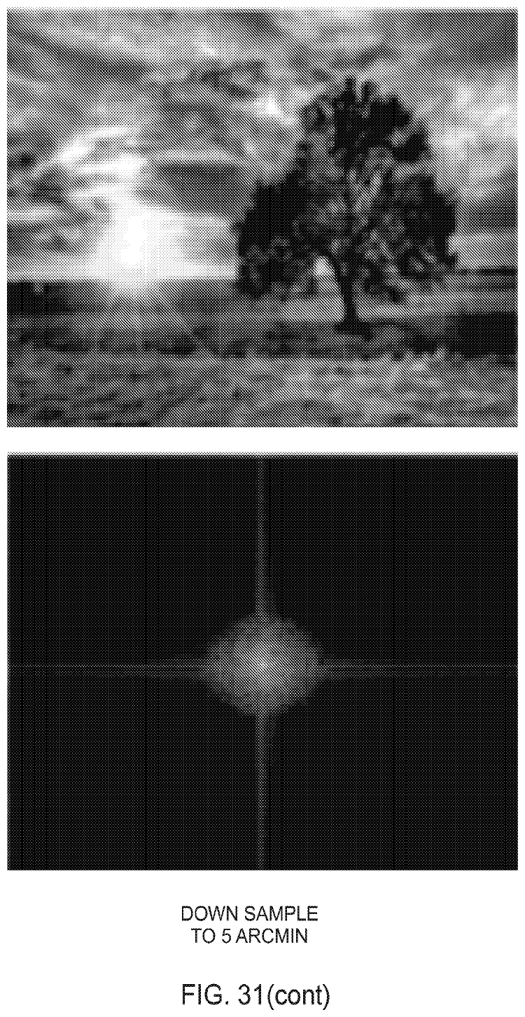

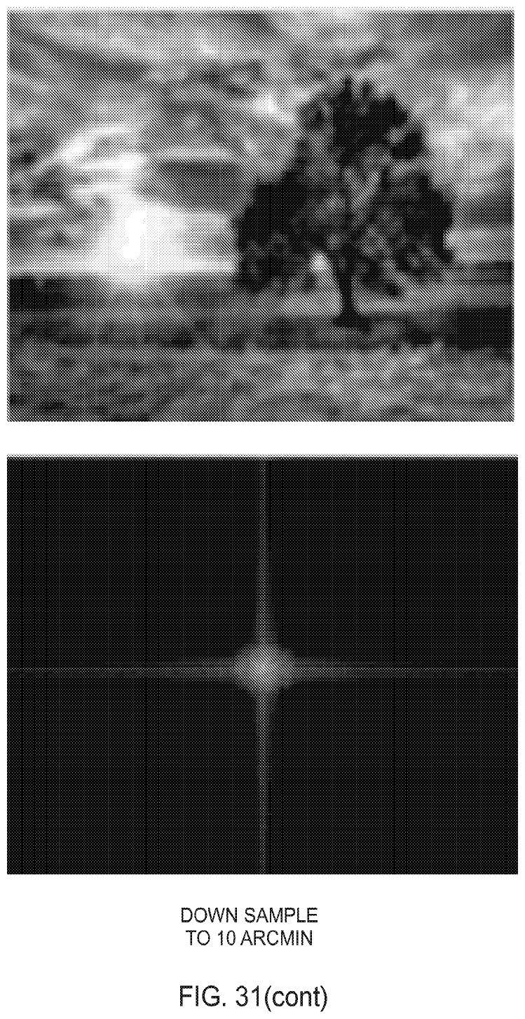

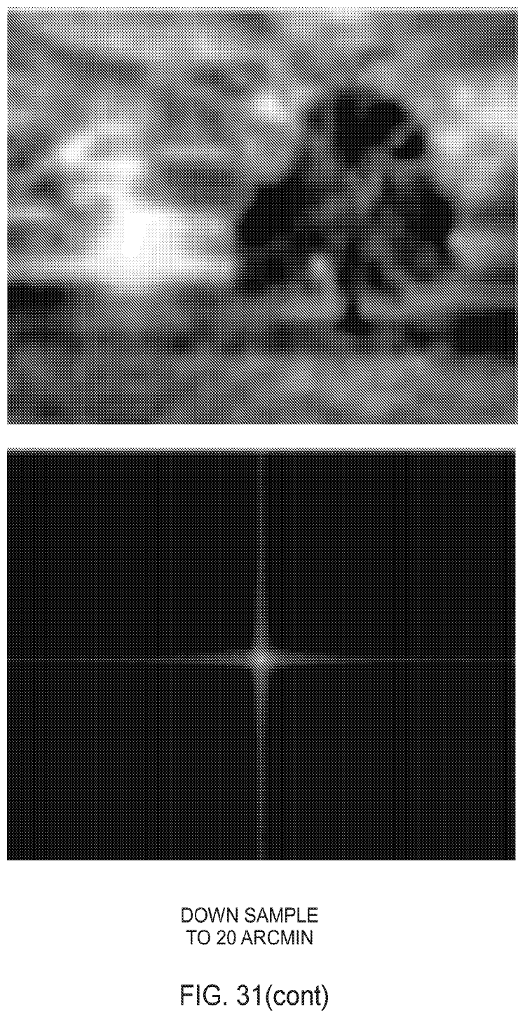

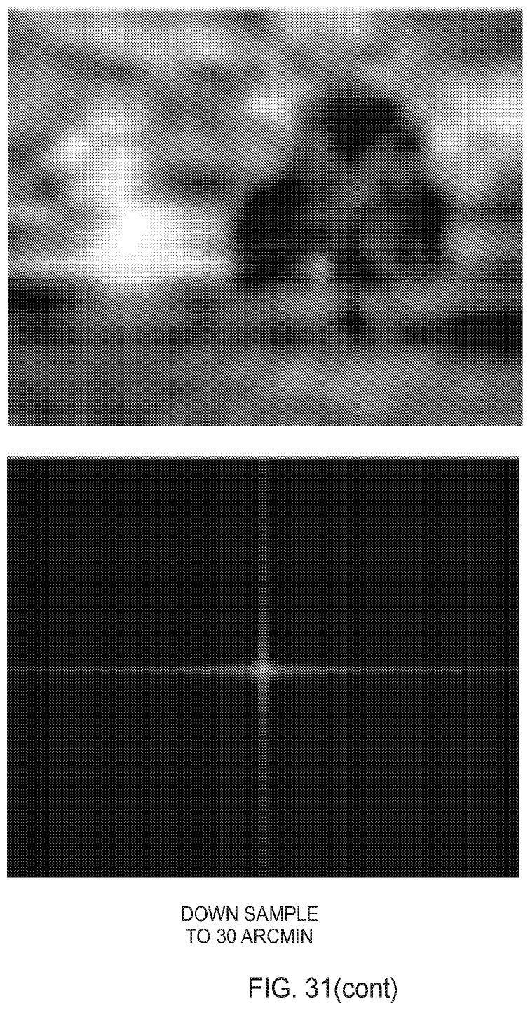

As we split each pixel modulation into two SLM equally, the command level of each pixel on the two LCoS needs to be re-calculated. However, even if we desired to equally distribute the pixel value into two SLMs, this process does not simply make a square root of the original image value. The microdisplay had a non-linear tone response curve, as we calibrated as shown in FIG. 26 and the associated text. That means, the luminance would not be the half value if the command level drops to the half of its initial value, due to the gamma correction for display luminance encoding. Moreover, the tone response now is field dependent, which means even for the same desired luminance, each pixel now has different pursued command level. A radiance rendering algorithm for resolving all the problems was developed, as its schematic diagram shown in FIG. 29. The modulation amplitude of each SLM could be acquired by taking square root of its original value (FIG. 29(1)). To get the desired luminance value, the corresponding pixel value should be calculated based on the display tone response curve for each SLM. LCoS1 of the prototype in FIG. 16 was the one responsible for low spatial frequency information. The downsampling was firstly act on the image if necessary (FIG. 29(2)), which is discussed below. The downsampled image was then encoded with the modified tone response curve. To correct image background non-uniformity, the LCoS1 tone response curve could be modified with the maximum luminance distribution. For each pixel, the tone response curve would be truncated and extracted with different absolute value, depending on their maximum luminance ratio. FIG. 31 shows an example of how to look up the corresponding pixel value based on tone response curve, where g₁′ . . . , g₁ⁿ and g₂ denote the inverse function of the two SLM tone responses, and where n stands for pixel count. The LCoS1 tone response curve would depend on the location of pixel, because of the brightness uniformity correction.

The LCoS2 image should be rendered as compensation to LCoS1 image. Because of the physical separation of two microdisplay panels, the LCoS1 image plane would have some displacements to the system reference image plane, which was set at the position of LCoS2 in FIG. 16. In this case, diffraction effects should be considered. The LCoS1 actual image at the reference image plane was actually blurred by the aberration-free incoherent point spread function (PSF). (Sibarita J B. Deconvolution microscopy[M]//Microscopy Techniques. Springer Berlin Heidelberg, 2005: 201-243):

$$\begin{matrix}PSF ( r , Δ z ) = {\vert 2 {\int }_{0}^{1} {J}_{0} ( \frac{2 π}{λ} NA \cdot r \cdot ρ ) exp \{ i \frac{2 π}{λ} \cdot σ \cdot {ρ}^{2} \} ρ d ρ \vert}^{2} & ( 6 ) \\ where σ = 2 Δ z {sin}^{2} \frac{α}{2} , & \end{matrix}$$

Δz is the displacement between LCoS1 and the reference image position; r is the radial distance; λ is the wavelength; ρ is the normalized integral variable on exit pupil; a is the half angle of the diffraction cone. The actual LCoS1 defocused image at the reference image plane can be treated as the original image convolved with its point spread function (FIG. 29(3)). LCoS2 desired luminance was then calculated by dividing blurred LCoS1 images from the total luminance. The image was then encoded by LCoS2 response. By using the HDR image radiance rendering algorithm, the desired pixel value C1ₙ and C2 on each SLM can be calculated as per FIG. 30, and the HDR image luminance could be well reproduced.

### Spatial Frequency Redistribution—Image Downsampling

An optional rendering procedure may be used to redistribute the image spatial frequency. It is not necessary for the relayed HDR HMD system, as the pixel on each display has one-to-one imaging correspondence. However, distributing spatial frequencies with different weighting onto two microdisplays may leave more alignment tolerance. Moreover, for the non-relayed HDR display engine which has one SLM nearer to and another SLM farther from the nominal image plane, weighting higher spatial frequency information on the microdisplay closer to the image plane might increase the overall image quality. FIG. 31 shows a target image and its frequency domain after downsampling by different low pass filters. However, though it is a good way to increase the alignment tolerance, especially when two SLM has a certain distance, down-sampling would also introduce some artifacts, which would be more obviously at the boundary and where grayscale has step change.

### System Performance

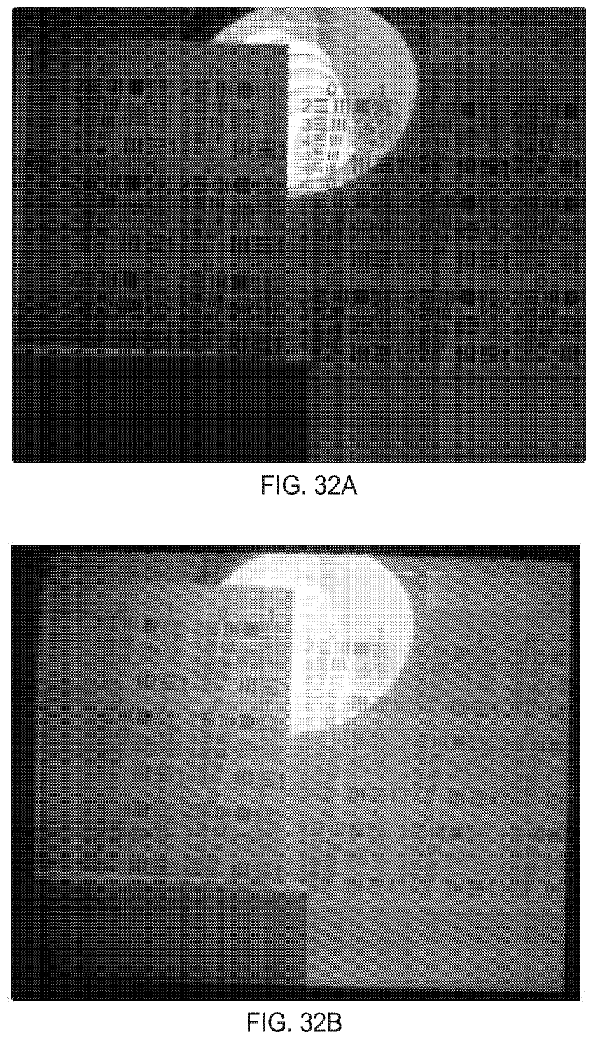

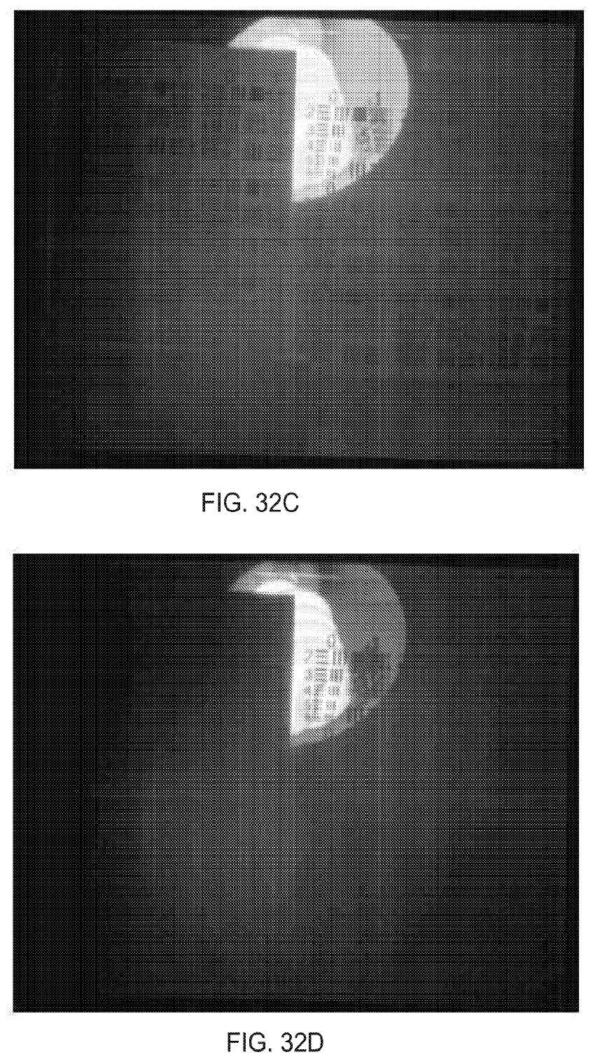

FIG. 32A shows an original target HDR image after tone-mapping to 8-bit. This tested HDR image was generated by the aforementioned method under the heading of “HDR image source and generation,” to merge images with multiple exposure. This synthetic image was processed with the radiance and alignment rendering algorithm disclosed above in connection with FIGS. 20, 29 and text under the headings of “Radiance map calibration” and “Image alignment algorithm,” and was then displayed on the two LCoS. A black-white camera was placed at the center of the HMD eyebox to capture the reconstructed scene. Due to lower bit depth of the camera, multiple images were captured and synthesized to one HDR image to achieve a dynamic range higher than that of a single image to better approach the dynamic range of the human eye. FIG. 32B shows the HDR HMD system performance. As a comparison, FIGS. 32C, 32D show the tone-mapping HDR image shown on LDR HMD, FIG. 32C, and LDR image shown on LDR HMD, FIG. 32D. Compared with the LDR HMD that only shows 8-bit depth image, in FIGS. 32C, 32D the proposed HDR HMD shows higher image contrast, with more details in both dark and bright areas, as well as keeping decent image quality.

A number of patent and non-patent publications are cited herein, the entire disclosure of each of these publications is incorporated by reference herein.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A display system having an axis and comprising:
first and second display layers; and
an optical system between said first and second display layers, the optical system configured to form an optical image of a first predefined area of the first display layer on a second predefined area of the second layer.

2. A display system according to claim 1, wherein said optical system is configured to form an optical image of said second area on said first area.

3. A display system according to claim claim 1, wherein the first and second layers are optical conjugates of one another.

4. A display system according to claim 1, wherein the second display layer is spatially separated from a plane that is optically-conjugate to a plane of the first display layer.

5. A display system according to claim 1, wherein said optical system is configured to establish a unique one-to-one imaging correspondence between the first and second areas.

6. A display system according to claim 1, wherein at least one of the first and second display layers is a pixelated display layer.

7. A display system according to claim 6, wherein the first area includes a first group of pixels of the first display layer, the second area includes a second group of pixels of the second display layer, and the first and second areas are optical conjugates of one another.

8. A display system according to claim 7, wherein at least one of the first and second groups of pixels includes only one pixel.

9. A display system according to claim 1, wherein the first display layer has a first dynamic range, the second display layer has a second dynamic range, and the display system has a system dynamic range a value of which is a product of values of the first and second dynamic ranges.

10. A display system according to claim 1, wherein said optical system is configured to image said first area onto said second area with a unit lateral magnification.

11. A display system according to claim 1, wherein ratios between each of dimensions of the second area and respectively-corresponding dimensions of the first area are substantially equal to m, wherein m is a lateral magnification of said optical system.

12. A display system according to claim 1, wherein the display system is a head mounted display.

13. A display system according to claim 1, comprising a light source disposed in optical communication with the first display layer, and wherein the first display layer is configured to modulate the light received from the source.

14. A display system according to claim 13, wherein the second display layer is configured to receive modulated light from the first display layer and configured to modulate the received light, and comprising an eyepiece for receiving the modulated light from the second display layer.

15. A display system according to claim 1, wherein the first display layer comprises a LCoS.

16. A display system according to claim 1, wherein the second display layer comprises a LCoS.

17. A display system according to claim 1, wherein the second display layer comprises an LCD.

18. A display system according to claim 1, wherein the optical system includes an optical relay system.

19. A display system according to claim 1, wherein the optical system includes a beam splitter.

20. A display system according to claim 1, wherein the optical system includes a polarized beam splitter.

21. A display system according to claim 1, wherein the optical system is telecentric at the first display layer.

22. A display system according to claim 1, wherein the optical system is telecentric at the second display layer.

23. A display system according to claim 1, wherein the first and second display layers are configured to spatially modulate light.

24. A display system according to claim 1, wherein the first display layer comprises a reflective spatial light modulation layer.

25. A display system according to claim 1, wherein the first display layer comprises a transmissive spatial light modulation layer.

26. A display system according to claim 1, wherein the second display layer comprises a reflective spatial light modulation layer.

27. A display system according to claim 1, wherein the second display layer comprises a transmissive spatial light modulation layer.
